(19) United States
(12) Patent Application Publication
(10) Pub. No.: US 2020/0143649 A1
(43) Pub. Date: May 7, 2020

(54) DISTRIBUTED THREAT DETECTION SYSTEM

(71) Applicants: Greg Coonley, Cumming, GA (US); Joseph Robert Gullo, Flowery Branch, GA (US); Douglas Neil Phillips, Mobile, AL (US)

(72) Inventors: Greg Coonley, Cumming, GA (US); Joseph Robert Gullo, Flowery Branch, GA (US); Douglas Neil Phillips, Mobile, AL (US)

(73) Assignee: Wahsega Labs LLC, Suwanee, GA (US)

(21) Appl. No.: 16/178,531

(22) Filed: Nov. 1, 2018

(51) Int. Cl. G08B 17/08; H04L 12/10; G06F 3/16

(52) U.S. Cl. CPC G08B 17/08; G06F 3/165; H04L 12/10

(57) ABSTRACT

A distributed threat detection system that can be installed in a facility, such as a school, office, factory, entertainment venue, etc. and monitor for trigger events that may be indicative of a threat. Sensors and/or detectors are distributed throughout the facility and the system is used to interconnect all of the sensors into a single control master. The sensors are distributed and interconnected through the use of distributed IP loads fed to a central control unit over PoE connections.

### CROSS-REFERENCE TO RELATED APPLICATIONS

U.S. Pat. No. 9,774,966 having the title of MULTI-SPEAKER CONTROL FROM SINGLE SMART MASTER SPEAKER, issued on Sep. 26, 2017 and U.S. Pat. No. 8,134,889 having the title SYSTEMS AND METHODS FOR AUGMENTING GUNSHOT LOCATION USING ECHO PROCESSING FEATURES and issued on Mar. 13, 2012 are hereby incorporated by reference.

### BACKGROUND

We have all been at home or at work and heard the news story blasting into our homes, office or cars bringing the dreadful news of another shooting at a school, a church, a coffee house, a concert, etc. It brings a sweeping tone of horror but mixed with a level of deniability feeling that it could never by your church, your movie theater, your office or, your child being rushed to the hospital or worse.

But in a world in which freedoms granted by the constitution can be abused to bring hurt, pain and sorrow to others, any measures that can be taken to reduce the risk may just be that one step that impedes the need for a call to two unsuspecting parents in the middle of the day.

Two of the critical areas of improvement in the industry include prevention of guns being brought into a facility by the general populous and quickly reacting to an escalating situation.

Advances in technology generally bring improvements across many sectors of life. Safety in the classroom has also greatly benefited from such advancements. Panic buttons in the classroom, automatic locks and alerting systems all have improved from advancements in technology. But as most parents would attest, scrimping on safety is not something that is appreciated. And thus, there is a need in the art to provide enhancements in school safety and to do so in a budget efficient manner.

### BRIEF SUMMARY

The present disclosure is directed to providing a distributed threat detection system that can be installed in a facility, such as a school, office, factory, entertainment venue, etc. and monitor for trigger events that may be indicative of a threat. Sensors and/or detectors are distributed throughout the facility and the system is used to interconnect all of the sensors into a single control master. One embodiment of the invention can be deployed as an intercom system within a school, as a non-limiting example. Once a triggering event occurs and is detected by one or more of the deployed sensors/detectors, the system activates any additional sensors that may be inactive to save power consumption, and the system gathers more information to identify what the triggering event actually is. Once the event is identified, it is analyzed along with other information such as environmental and situational factors, as well as other factors, to determine if there is a plausible explanation for the occurrence of the triggering event. If this analysis determines that the triggering event is actually a threat, further information is gather to ascertain the nature and extent of the threat, as well as to monitor further escalation or de-escalation of the event and any movement of the event source. Such information can be used to identify and modify remedial measures to be taken in response to the threat.

An exemplary embodiment is a system that extends the functionality of distributed IP devices within a locale to detect and isolate threat activity. For instance, an intercom system utilizing IP speakers would be utilized as an environment for the exemplary embodiment. Thus, the distributed system includes a plurality of IP loads spaced throughout the locale with each IP load including one or more sensors or detectors. A master controller is communicatively coupled to each of the plurality of IP loads through a PoE port. Each of the sensors associated with the IP loads are communicatively coupled to and controlled by a sensor master that includes a controller. The sensor master may be part of the master controller, the IP load controller, a separate device or a combination of two or more of these. The sensor master can selectively turn on and off each of the sensors, monitor activity in the vicinity of the sensors when they are turned on; detect an activity that is indicative of a potential threat; and send notification to the master controller of the potential threat. The master controller operates to receive such notifications, identify a category of the threat; and initiate contingency procedures based on the category of the threat.

In some embodiments, one or more of the sensors may be microphones that can detect a gunshot sound. In some embodiments, the one or more of the sensors are optical sensors that can detect a muzzle flash. In some embodiments, one or more of the sensors are heat sensors and can detect a fire.

When the system detects a potential threat, the system can respond by: turning on all of the microphones in the local; identifying the location of the gunshot sound; locking access doors to rooms in which the gunshot sound was not detected; and/or initiating a call to the police, as non-limiting examples.

A variety of IP loads can be used as end points for receiving communication from the master controller, responding and controlling devices within the distributed system, including the sensors. In some embodiments, the IP loads are speaker systems that include: a master speaker; a control module; a slave speaker system interface; and a slave speaker system. Further, the slave speaker system, which is also an IP load, may include: an interface to the slave speaker system interface; an analog speaker; a sensor; and one or more control interfaces.

In operation, the control module registers the slave speaker system with the master controller. Further, the control module obtain commands received at the master speaker system intended for the slave speaker system and then controls the operation of the slave speaker control system in accordance with the received commands through the slave speaker interface. In some embodiments, the slave speaker interface is configured to provide power from the single PoE port to the slave speaker system.

These and other embodiments, features, aspects and functionality of the various embodiments are explained further in the detailed description.

### BRIEF DESCRIPTION OF THE SEVERAL VIEWS OF THE DRAWING

FIG. 1 is a functional block diagram illustrating an exemplary configuration based on IP loads that can support embodiments of the distributed threat detection system.

FIG. 2 is a block diagram illustrating an exemplary configuration based on IP loads that can support embodiments of the distributed threat detection system.

FIG. 3 is a block diagram illustrating the single room deployment of embodiments of the SCS.

FIG. 4 is a block diagram illustrating the single room deployment of embodiments of the SCS with multiple speakers.

FIG. 5 is a block diagram illustrating the multiple room deployment of embodiments of the SCS.

FIG. 6 is a functional block diagram of the components of an exemplary embodiment of system or sub-system operating as a controller or processor 500 that could be used in various embodiments of the disclosure for controlling aspects of the various embodiments.

FIG. 7A is a portion of a flow diagram to illustrate exemplary steps in a process for establishing and operating an embodiment of a multiple rooms/zones with each room/zone having a speaker as presented in the deployment of FIG. 5.

FIG. 7B is a portion of a flow diagram to illustrate exemplary steps in a process for establishing and operating an embodiment of a multiple rooms/zones with each room/zone having a speaker as presented in the deployment of FIG. 5.

FIG. 7C is a portion of a flow diagram to illustrate exemplary steps in a process for establishing and operating an embodiment of a multiple rooms/zones with each room/zone having a speaker as presented in the deployment of FIG. 5.

FIG. 7D is a portion of a flow diagram to illustrate exemplary steps in a process for establishing and operating an embodiment of a multiple rooms/zones with each room/zone having a speaker as presented in the deployment of FIG. 5.

FIG. 7E is a portion of a flow diagram to illustrate exemplary steps in a process for establishing and operating an embodiment of a multiple rooms/zones with each room/zone having a speaker as presented in the deployment of FIG. 5.

FIG. 7F is a portion of a flow diagram to illustrate exemplary steps in a process for establishing and operating an embodiment of a multiple rooms/zones with each room/zone having a speaker as presented in the deployment of FIG. 5.

FIG. 7G is a portion of a flow diagram to illustrate exemplary steps in a process for establishing and operating an embodiment of a multiple rooms/zones with each room/zone having a speaker as presented in the deployment of FIG. 5.

FIG. 7H is a portion of a flow diagram to illustrate exemplary steps in a process for establishing and operating an embodiment of a multiple rooms/zones with each room/zone having a speaker as presented in the deployment of FIG. 5.

FIG. 7I is a portion of a flow diagram to illustrate exemplary steps in a process for establishing and operating an embodiment of a multiple rooms/zones with each room/zone having a speaker as presented in the deployment of FIG. 5.

FIG. 7J is a portion of a flow diagram to illustrate exemplary steps in a process for establishing and operating an embodiment of a multiple rooms/zones with each room/zone having a speaker as presented in the deployment of FIG. 5.

FIG. 7K is a portion of a flow diagram to illustrate exemplary steps in a process for establishing and operating an embodiment of a multiple rooms/zones with each room/zone having a speaker as presented in the deployment of FIG. 5.

FIG. 8 is a flowchart illustrating exemplary steps in responding to a thread detection interruption.

FIG. 9 is a flow diagram illustrating exemplary steps, actions or processes that can be implemented in a software/firmware enhancement to an existing system as well as by a dedicated box attached to the network of an existing system.

### DETAILED DESCRIPTION

The present invention, as well as features and aspects thereof, is directed towards enhancing security in an environment and, more particularly, towards using threat detection through audio monitoring of an environment to trigger security actions. U.S. Pat. No. 9,774,966 discloses a cost effective speaker/controller system and, more specifically relates to a multiple speaker/control system that is configured to allow a single master controller to have connectivity, communicability and control over multiple speaker/controllers in a cluster of speaker/controllers, through a communications connection with a single master speaker/controller in the cluster. The present disclosure focuses on enhancements to such a system, as well as other similar systems, that allow for threat detection using a deployed facility communication/monitoring system.

Turning now to the figures, several embodiments of the speaker/control system, as well as features and aspects thereof are presented in further detail.

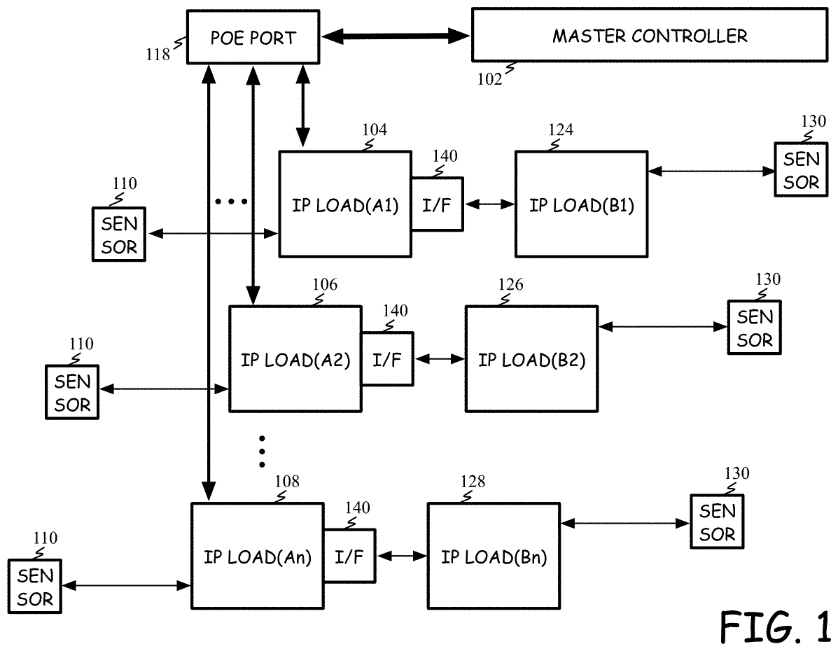

FIG. 1 is a functional block diagram illustrating an exemplary configuration based on IP loads that can support embodiments of the distributed threat detection system. It should be appreciated that a functional block diagram is used to illustrate separate areas of functionality as opposed to an actual physical structure. As such, the various blocks illustrated in a functional block diagram may actually be distributed among hardware components within the system, as well as software or instructions running on a controller and a combination of both hardware and software.

In the illustrated embodiment, a master controller 102 serves as the control center for the system. The master controller 102 can be used for sending signals and receiving signals from various components within a system, including but not limited to IP Load(A1) 104, IP Load(A2) 106 and IP Load(An) 108. It should be appreciated that while three IP Loads are illustrated, the system can be expanded to include any number of IP loads from one to “n”.

Each of the IP Loads 104, 106 and 108 are illustrated as interfacing with a sensor device 110. The sensor may be any of a variety of devices or systems that are used to perceive an activity that may be considered or indicative of a threat. It should be appreciated that threats may come in many forms, including natural occurrences and man-made occurrences. As such, various types of sensors or detectors may be used to perceive one or more of a wide variety of triggers and then to analyze those triggers to determine if there is concern of a threat, what level of a threat and isolate the location of the threat. As non-limiting examples, the sensor devices 110 may be used to detect loud noises (e.g. gunshots, broken glass, shouting, words of threat, cries for help, gushing water, cracking of fire or electrical wiring, etc.), environmental changes (e.g. temperature extremes, moister, wind, percussions, smoke, hazardous odors, light flashes, flames, etc.) and questionable anomalies (e.g., humans lying flat on the ground or falling over, people rushing in panic, visual detection of firearms, arms being raised in the air, blood, etc.). One or more sensors/detectors can thus be used to identify one or more of the above-listed events or situations, and along with artificial intelligence or algorithmic processing certain threat risks can be identified from the perceived triggers listed above as well as other triggers.

For instance, in one embodiment, microphones can be used to detect loud noises, such as a gunshot. However, a gunshot may acoustically resemble a book falling flat on the floor. Similarly, in one embodiment, light sensors or optical sensors may be used to detect flashes of light. However, a gunshot may resemble a cigarette light. Thus, in many embodiments, in addition to just using sensors/detector, additional processing and analytics can be performed in identifying and determining a threat. For instance, in the two samples above, using microphones and optical sensors to identify a loud noise and the presence of a light flash would lend much more certainty to a gunshot being detected.

In some embodiments, the IP Loads may also be used to extend the distributed environment to other IP Loads. For instance, an IP Load, such as a master IP Load, may include an interface to one or more slave IP Loads. Thus, master IP Load(A1) may include an interface and controller to interface with slave IP Load(B1) 124. Likewise, master IP Load(A2) could control slave IP Load(B2) 126 and master IP Load(An) could control slave IP Load(Bn) 128. The slave IP Loads B1-Bn may interface to one or more sensors 130. It should be appreciated that a master IP Load my interface to zero, one or more slave IP loads.

Thus, it should be appreciated that embodiments of the present invention provide a distributed system for detecting or perceiving events or triggers and analyzing these events or triggers to ascertain the presence of and the degree of a risk as well as to track the threat if it is moving within the distributed system. But as described above, an event or trigger can be quite varied and determining whether or not the detected events/triggers constitute a threat can be a complicated process.

For instance, just looking at one category of events or triggers can illustrate the complexities, such as, for example, detecting a gunshot. When a gun or similar weapon is discharged, there are basically three key triggers or events that can used to identify that the action has occurred: sound, light and shock.

The impulse sound wave generated by discharging a firearm can range from 120 dB to 140-190 dB depending on the caliber, barrel length and other characteristics of the firearm. This sound is described as sound pressure level or SPL. In addition, when the gun powder within the projectile explodes, an optical flash is created at the exit of the muzzle. Further, a shock wave may also be created by the projectile moving through the air at supersonic speed for firearms and ammunition that generate movement, measured in feet per second (FPS) that exceeds the speed of sound, such as 1200 FPS or greater.

The impulse sound wave or sound pressure can be detected and/measured using microphones or acoustic sensors. Microphones generally have a polar pattern describing their sensitivity as a function of the direction of a sound source. Many microphones have an omnidirectional polar pattern which means their sensitivity is the same in all directions. Some microphones are directional, meaning that they are move sensitive to sound in certain directions. It may be necessary to distinguish gunfire acoustics from other similar sounds, such as fireworks explosions, cars backfiring, clapping or slapping hands, books falling flat, etc. This can be accomplished using signatures on the sound waves and/or using an array of sensors to detect sound propagation. For example, urban areas typically exhibit diurnal noise patterns where background noise is higher during the daytime and lower at night, where the noise floor directly correlates to urban activity (e.g., automobile traffic, airplane traffic, construction, and so on). During the day, when the noise floor is higher, a typical handgun muzzle blast may propagate as much as a mile. During the night, when the noise floor is lower, a typical handgun muzzle blast may propagate as much as 2 miles. Therefore, a co-located array of microphones or a distributed array of acoustic sensors that hear a muzzle blast at different times can contribute to calculating the location of the origin of the discharge provided that each microphone/sensor can specify to within a millisecond when it detected the impulse. Using this information, it is possible to discriminate between gunfire and normal community noises by placing acoustic sensors at wide distances so that only extremely loud sounds (i.e., gunfire) can reach several sensors. This is known as a spatial filter. The spatial filter can also be utilized within a facility, such as a school or office setting that includes multiple rooms connected by various hallways. Utilizing an array of sensors to set up a spatial filter allows a system to pin point the location of the blast, measure propagation of the sound waves and measure the distance of the sound waves. Further, the magnitude of the can also be detected through signal processing of the received sound wave. By using an array of sensors, the magnitude at each sensor can be measured and thus the location of the noise source can be determined roughly by identifying the sensor with the highest sound magnitude. However, triangulation may also be used by selecting multiple sensors, measuring the magnitude of the sound wave and propagation delays to pinpoint the location of the sound source. Triangulation is the process of determining the location of a source by using known information about other locations relative to the location of the source. For instance, one technique involves forming triangles in which one point of the triangle coincides with a known point and another point of the triangle coincides with the location of the source. As another example, when a civil engineer is conducting a survey, triangulation involves angle measurements, rather than measuring distances to the point directly. This process is referred to as trilateration. Another technique uses both angles and distance measurements and is referred to as triangulateration.

When identifying the location of an acoustic source, the sound field, which can be described using physical quantities like sound pressure and particle velocity, can be examined. By measuring these properties, it is possible to identify a source direction. Besides considering microphones that measure sound pressure, it is also possible to use a particle velocity probe to measure the acoustic particle velocity directly. The particle velocity is another quantity related to acoustic waves however, unlike sound pressure, particle velocity is a vector. By measuring particle velocity one obtains a source direction directly. Other more complicated methods using multiple sensors are also possible. Many of these methods use the time difference of arrival (TDOA) technique.

Many scholarly articles are available on the topic of triangulation techniques. For instance, How Far Off Is That German Gun? How 63 German guns were located by sound waves alone in a single day, Popular Science monthly, December 1918, page 39, which is available by GOOGLE at the following URL https://books.google.com/books?id=EikDAAAAMBAJ&pg=PA39, and Time-of-arrival based localization under NLOS conditions published IEEE Transactions on Vehicular Technology (Volume: 55, Issue: 1, Jan. 2006) as well as other publications that one of ordinary skill in the art may review.

Another way to detect a gunfire is by detecting optical flashes. Optical flashes can be detected using optical and/or infrared sensing techniques; however, there must be a line of sight from the sensor to the weapon, or at least a reflective access, otherwise the flash cannot be detected. Because only optical flashes are detected, such systems are typically only capable of determining the bearing of a discharge relative to the sensor unless multiple systems triangulate the shot range. Multiple gunshots, fired from multiple locations at nearly the same time, are easily discriminated as separate gunshots because the sensors generally utilize a focal plane array consisting of many sensitive pixels. Each pixel in the entire focal plane (e.g. 640×480 pixels) is constantly evaluated.

Measuring the shockwave of a ballistic travelling through the air can also be used to identify a weapon being fired. The projectile generally must travel within 50 to 100 meters of a sensor in order for the sensor to hear the shockwave. The combination of a muzzle blast and a shockwave provides additional information that can be used along with the physics of acoustics and sound propagation to determine the range of a discharge to the sensor, especially if the round or type of projectile is known. A system that can hear minute differences in the arrival time of the muzzle blast and also hear a projectile's shockwave “snap” can calculate the origin of the discharge. Multiple gunshots, fired from multiple locations at nearly the same time, such as those found in an ambush, can provide ambiguous signals resulting in location ambiguities.

Infrared detection systems can also be utilized for flash detection. The optical detectors have an added advantage at night. At night, the signature of the gunshot will not be partially hidden within the background of solar infrared contributions. Most flash suppressors are designed to minimize the visible signature of the gunfire. Flash suppressors break up the expanding gases into focused cones, thereby minimizing the blossoming effect of the exploding gasses. These focused cones contain more of the signature in a smaller volume. The added signal strength helps to increase detection range.

As previously mentioned, it may be of paramount importance to distinguish a gunshot from other impulse noises, such as cars backfiring, doors slamming, items dropping, fireworks, etc. Many techniques can be used to distinguish between gunfire and similar noises. As previously mentioned, and as more thorough presented in U.S. Pat. No. 8,134,889 (incorporated above by reference) spatial filter is one technique that can be used. Other techniques may include an analysis of the spectral content of the sound, its envelope, and other heuristics. Yet another technique is based on the use of artificial neural networks that are trained and then listen for a sound signature in acoustic events. Like other acoustic sensing systems, the artificial neural networks are fundamentally based on the physics of acoustics, but they analyze the physical acoustic data using a neural network. Information in the network is coded in terms of variation in the sequence of all-or-none (spike) events, or temporal patterns, transmitted between artificial “neurons”. Identifying the nonlinear input/output properties of neurons involved in forming memories for new patterns and developing mathematical models of those nonlinear properties enable the identification of specific types of sounds. These neural networks can then be trained as “recognizers” of a target sound, like a gunshot, even in the presence of high noise.

Thus, these techniques as well as other techniques can be used to identify and distinguish a gunshot. Once the gunshot is identified, the standard triangulation methods can then be used to locate the source of the gunshot.

A gunshot detection system can be set up using a variety of architectures, with each one having different capabilities and being more suitable for certain applications. One possible architectures is a stand-alone systems with local microphone arrays. Another architecture can be based on distributed sensor arrays (“wide-area acoustic surveillance”). The local microphone or sensor array system is generally more suitable for immediate detection and alerting of a nearby shooter in the vicinity of the system, such as the facility in which the system is deployed (i.e., office space, school, entertainment venue, etc.). The distributed sensor arrays are more suitable for use in protecting large areas such as cities, municipalities, critical infrastructure, transportation hubs, and military operating bases.

A goal of the stand-alone systems, which is the architecture used to describe various embodiments of the present invention; however, the present invention should not be construed to be limited to such an architecture, is to immediately alert human targets or collateral so they may take evasive and/or neutralization action. Such systems generally consist of a small array of sensors separated by a precise small distance. Each sensor detects the sounds of gunfire at minute differences in time allowing the system to calculate the range and bearing of the origin of the gunfire relative to the system. It should be appreciated that systems may use one or multiple types of sensors to validate the classification of a sound and threat and to isolate the location of the same.

Thus, returning to the environment illustrated in FIG. 1, each of the sensors 110 and 130 may include any one or multiples of the afore-described sensors/detectors, may include a local array of such sensors or a single sensor, or various combinations that are selected based on environment, location, etc. Each of the sensors 110 130 are accessed, controlled and communicated with through an IP Load as illustrated in FIG. 1.

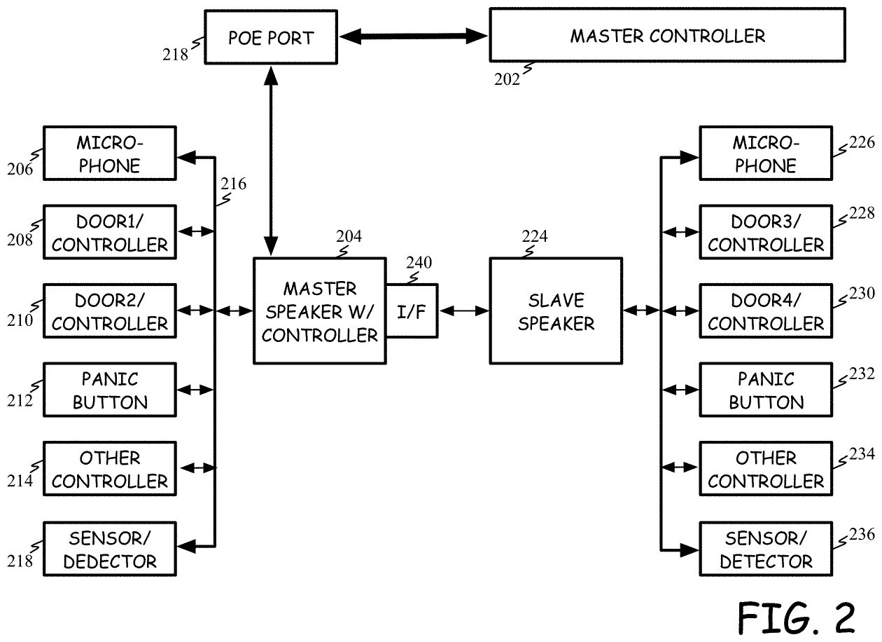

FIG. 2 is a block diagram illustrating an exemplary configuration in which the IP Load is a speaker/control system (SCS). In general, a master controller 202 serves as a central control center for the system. The master controller 202 can be used for sending signals and receiving signals from various components within a system, including but not limited to a master speaker with controller 204. The master speaker with controller 204 can be a commercially available speaker/controller system, like the one available from WAHSEGA LABS and VALCOM, or a proprietary speaker and controller system. The afore-described commercially available products include a communication and audio announcement system commercially referred to as INFORMACAST.

As those skilled in the art will understand, INFORMACAST is a voice over IP network protocol that is generally designed for providing live and recorded audio paging. The protocol allows endpoints (such as public addressed speakers) to autonomously announce their presence and capabilities (such as recording or the input and output definitions) and configure themselves to play audio broadcasts. The protocol is built largely on standard technologies including SLP for locating a configuration server, TFTP for obtaining configuration data, HTTP and XML for registering devices and transmitting commands, and multicast RTP for audio playback and recording.

SLP (which is an acronym for Service Location Protocol) is a service discovery protocol that allows computers and other devices to find services in a local area network without prior configuration. SLP has been designed to scale from small, unmanaged networks to large enterprise networks. Those skilled in the art will be familiar with SLP but further information regarding the protocol can be found in the standards documents RFC 2608 and RFC 3224.

SLP is used by devices to announce services on a local network. Each service must have a URL that is used to locate the service. Additionally, it may have an unlimited number of name/value pairs, called attributes. Each device must always be in one or more scopes.

It should be appreciated that the master speaker with control may also be a proprietary product that operates on a proprietary system that is based on a technology other than INFORMACAST, however, the benefits of the present invention or most readily realized in the INFORMACAST environment utilizing the commercially available speaker/controllers.

The master speaker with controller (hereinafter master speaker) 204 is illustrated as interfacing with several classes and types of devices. In the illustrated embodiment, the master speaker 204 interfaces to a microphone 206, a controller for a first door 208, a controller for a second door 210, a panic button 22, an “other” controller 214 and one or more sensor/detectors 220. The “other” controller is listed because there are a wide variety of devices that can be controlled through various embodiments of the SCS. A few non-limiting examples may include the lights, an alarm and a clock. The master speaker 204 may be connected to each of the devices through a bus type structure 216 or by dedicated lines that run to each device, with each device being associated with a particular input/output of the master speaker 204.

The master speaker 204 is shown as interfacing to the master controller through a Power over Ethernet port or PoE port 218. A PoE port is any of several standardized or ad-hoc systems that pass electrical power along with data on Ethernet cabling. A PoE port allows a single cable to provide both data connection and electrical power to devices, such as the master speaker 204.

In operation, when the master speaker 204 is attached to the PoE port 218, the master speaker announces 204 its presence and capabilities to be recognized by the master controller 202. Once connected and interfaced to the master controller 202, the master speaker 204 can be utilized by addressing particular request through INFORMACAST to accomplish various tasks. For instance, the master controller 202 can send audio or announcements to the master speaker 204, send a trigger to lock either one or both of the doors 208 210, or send other controlling commands to other controllers 214. In addition, the master speaker 204 can receive inputs from the various devices and forward the same to the master controller 202. For instance, audio can be detected at the microphone controller 206 from a microphone, which could be constant on, switch on or push to talk style microphone as an example.

The master speaker 204 is also illustrated as being communicatively coupled to a dumb or slave speaker 224. The master speaker 204 can be communicatively coupled to the slave speaker 224 in a variety of manners and using a variety of technologies. In one embodiment the master speaker 204 is communicatively coupled to the slave speaker 224 through a CAT 5/6 Ethernet cable. However, it will be appreciated that other wired, wireless and optical technologies may also be utilized, including but not limited to RF, BlueTooth, WiFi etc.

The slave speaker 224 is illustrated as interfacing to a similar set of controllers as the master speaker 204. Thus, the dumb speaker 224 is illustrated as interfacing to a microphone 226, a controller for a third door 228, a controller for a fourth door 230, a panic button 232, an “other” controller 234 and one or more sensor/detectors 236.

The master speaker 204 interfaces to the slave speaker 224 through an interface controller 240. The interface controller 240 not only sends and receive audio and control signals to the slave speaker 224, but it also provides power to the slave speaker 224. Thus, the master speaker 204 is the only device that directly interfaces to the PoE 218 and, it passes the power from the PoE 218 to the slave speaker 224.

In operation, when the slave speaker 224 is connected to the master speaker 204 through the interface 240, the master speaker 204 performs the necessary protocol transmissions required by INFORMACAST to have the slave speaker 224 recognized as being present in the system and identifying its capabilities. Once the master controller 202 recognizes the slave speaker 224, the slave speaker 224 can be utilized by addressing particular request through INFORMACAST to accomplish various tasks.

The slave speaker 224 is controlled by the master speaker 204 capturing INFORMACAST communications directed to the slave speaker 224 and then repackaging or relaying the communications to the slave speaker 224 through interface controller 240. Further, any communications resulting from activity from the slave speaker 224 and/or the devices connected to the slave speaker 224 are sent to the master speaker 204 through the interface controller 240. These communications are then packaged or relayed to the master controller 202. Thus, the communications between the master speaker 204 and slave speaker 224 may conform to INFORMACAST protocol or be a proprietary protocol that is converted to INFORMACAST protocol by the master speaker 204 and or the interface controller 240.

In the illustrated embodiment, the sensor/detectors 218 and 236 (which may also include the microphones 206 and 226 can be utilized to detect activity that may be probative of a threat. As previously mentioned, this may include a wide variety of activity including hostile words and/or radical motions typical of a terroristic attack, excessive heat characteristic of a fire, shattering glass, gunshots, etc. The sensor/detectors 218 236 may be configured to sense of detect any or all of a variety of different activities. The identification of a potential threat is a multi-step process. The first step includes sensing or detecting an event, such as excessive heat, noise, moisture, etc. The next step is performing heuristics or running an algorithm based on the characteristics of the event, as well as other environmental, situational, and known factors to ascertain whether the event or events is indicative of a threat. For example, on a military base, a cannot is always fired at 5:00 pm to coincide with the lowering of the flag and playing of taps. This would be considered situational factor that would be considered in determining if the repercussion is a local gunshot or not. Other non-limiting examples may include the date (i.e., fourth of July, New Years, etc.), scheduled activity (such as rehearsing for a play, an Easter Egg hunt, playing hide-and-go-seek, etc.) that may look like radical motions typical of a terroristic attack or hostile words.

When an event is detected, the event is analyzed in view of the other environmental, situational, and known factors to determine what the event is and if it may be a threat. For instance, an impulse sound wave is received and the analytics identify it as a gunshot. If the other environmental, situational, and known factors do not offer a plausible explanation as to detected event, then the next step in the process may include ascertaining the threat. This may include examining the other sensors/detectors 218 236 to identify the location of the event and the extent of the event. For instance, if the event is a gunshot, the sensors/detectors may be examined and analyzed to identify the location of the gunshot. As previously described, this process may include using triangulation or other techniques. If the event is excessive heat indicative of a fire, then other sensors/detectors can be examined to identify the extent of the fire.

Finally, once the threat is identified and ascertained, then remedial measures can be identified and invoked to alleviate or reduce the threat and to provide an enhanced level of safety. Remedial measures can vary greatly depending on the identified threat and the extent of the threat. For instance, if the event is a gunshot, the location of the gunshot can be identified as previously described, and then areas that are isolated from the gunshot can be automatically locked to provide protection to others. For instance, in a school setting, if a gunshot is detected in one classroom, the other classrooms may automatically be locked to prevent the threat from entering another classroom. Further, if the system includes spot lights, the spot lights can be turned on and focused on the source of the gunshot, potentially retarding the view of the shooter. In addition, the optical or infrared sensors can train and lock onto the source of the gunshot and then track the movement of the assailant. Depending on the location of the assailant, additional actions may be taken. For instance, if the assailant can be isolated into a confined space, such as a hallway, then all other doors can be locked to prevent further damage.

If the identified threat is a fire, the locations and extent of the fire can be ascertained and optimal escape routes can be illuminated. In addition, fire doors can be strategically released and sprinkler systems selectively activated to mitigate the damage from the fire and the sprinkler system.

Further, emergency personnel can be notified about the threat and the location of threat. This information can be utilized by first responders to strategically know how to address the threat. For instance, the location of a gunshot source would help law enforcement officers to strategize the best way to enter an establishment and neutralize the assailant.

Thus, the multi-step process has been described as: (1) detecting one or more events; (2) analyzing the event(s) to determine if it is indicative of a threat; (3) ascertain the extent of the threat and (4) identify and employ remedial measures.

In the various embodiments, these steps can be performed in hardware, software and a combination of both. In addition, the functions can be performed by the master controller 202, the master speaker controller 204, the sensor/detector devices 2018 236 as well as a combination of two or more of any of these elements.

Deployment Configurations.

Embodiments of the SCS can be deployed, installed or configured in different operating modes. As a non-limiting example that is not intended to limit the scope of various embodiments, three general operational configurations are described:
(1) Single room single sensor/detector
(2) Single room, multiple sensors/detectors
(3) Multiple rooms/zones with each room/zone having one or more sensor/detectors

While the hardware and software utilized for each such deployment can be the same, it will be appreciated that alternatively, some significant cost savings can be realized by eliminating certain elements from a deployed speaker. For instance, use of a commercially available master speaker includes a device that comprises the analog speaker, a hardware element and software that runs on the hardware element. It will be appreciated the combination of the hardware element and software could actually be accomplished completely in hardware, hardware and firmware, hardware and downloadable software, etc. Thus, the present embodiments are not limited to any particular configuration.

In some embodiments, the slave speaker also includes an analog speaker and a smaller, more simple hardware/software controller (slave controller). For instance, the smaller controller may be configured to only drive the speaker, microphone, sensor/detector and a wall panel. The slave controller can be connected to the master speaker with a single RJ45 connector using Cat5 cable as a non-limiting example. Such a configuration would provide power to the slave speaker 224, line-level audio and a UART such that the master speaker 204 can control the slave speaker 224. All of the application logic and audio can thus be processed by the master speaker 204 thus allowing the slave controller to be a much simpler and less expensive device that is only required to amplify audio and operate the input/output controls based on commands exchanged with the master speaker 204.

(1) Single Room with Single Speaker

(a) Single Room Single Analog Speaker

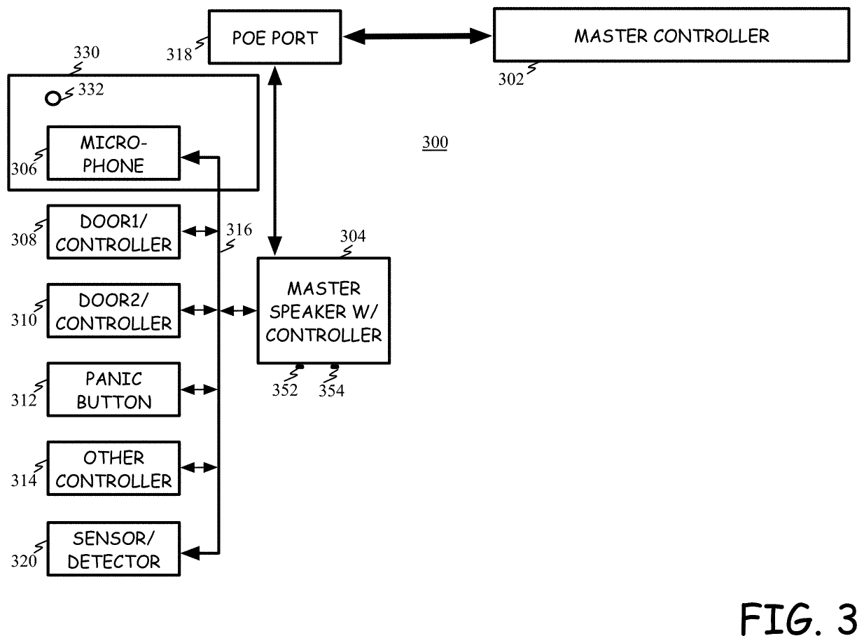

FIG. 3 is a block diagram illustrating the single room deployment of embodiments of the SCS. It should be appreciated that while the several embodiments, as well as features and aspects thereof, are presented herein as being deployed in a classroom setting, the various embodiments can be deployed in a variety of settings including offices, factories, lecture halls, churches, airports, hotels, etc. The single room deployment includes a master speaker as previously described 304, but it should be appreciated that the master speaker system can be replaced with any IP based load, such as sensors, microphone, etc., and the master speaker system is just provided as an illustrative embodiment. The embodiments will again be described with reference to an INFORMACAST based system but, those skilled in the art will appreciate that other protocols and operating systems may likewise be utilized in various embodiments of the SCS. Thus, once the master speaker 304 is connected to the system and/or turned on, the master speaker 304 operates to follow INFORMACAST specifications to discover its configuration. Once the configuration is identified, the master speaker registers itself with the master server 302 as a speaker. The master speaker 304 is then able to receive commands from the master controller 302. In the initialized and deployed state, the master speaker 304 receives power, data, audio signals and control commands through the PoE port 318 from the master controller 302, and transmits the data, audio signals, responses and status to the master controller 302. It should also be understood that although the various figures only show one master speaker as interfacing to the master controller, there can actually be any number of master speakers or other devices that are each individually addressable by the master controller using the INFORMACAST protocols.

The master speaker 304 may receive a command to start and stop audio broadcasts. Thus, the master controller can send out a broadcast signal and selectively enable or disable the various master controllers from delivering the audio broadcast to the analog speaker of the master speaker 304.

This embodiment my include a single sensor/detector 320 or an array of sensors/detectors being communicatively coupled to the master controller 302 and master speaker 304. To conserve power, in some embodiments only a single sensor may be active, constantly listening for or scanning for an event that may be indicative of a threat. Once an event is detected, the remaining sensors/detectors and then be activated to help identify and isolate the event. In other embodiment, each of the sensors can remain on at all times.

(b) SIP Endpoint

The Session Initiation Protocol (SIP) is a very flexible protocol that has great depth. It was designed to be a general-purpose way to set up real-time multimedia sessions between groups of participants. For example, in addition to simple telephone calls or VOIP calls, SIP can also be used to set up video and audio multicast meetings, or instant messaging conferences. The master speaker 304 is configured at startup of the system to operate as a SIP endpoint. The setup can be accomplished by switch settings, software settings, etc. At startup, the software operating in conjunction with the master speaker 304 reads configuration stored in its nonvolatile memory and prepares itself as a SIP endpoint (either by registering with its configured SIP server, or by preparing itself as a peer-to-peer SIP endpoint without registration). The master speaker may set up one or more SIP accounts per channel.

SIP and RTP (Real-Time Transport Protocol) calls can be established in full-duplex or half-duplex mode depending upon the configuration of the speaker and microphone. In half-duplex mode, the master speaker 204 monitors the audio from the peer using VAD (voice/audio detection). When the peer has sufficient audio, it plays that audio on the speaker and mutes the microphone. When the peer no longer has sufficient audio, it unmutes the microphone so that local audio can be heard, and mutes the speaker.

(c) Multiple Calls

The master speaker 304 can be configured to allow multiple simultaneous calls. This capability may apply to INFORMACAST audio broadcasts which are played simultaneously as well as SIP calls, which are conferenced together. As a non-limiting example, in INFORMACAST audio broadcasts, it may be desirable to play multiple audio broadcasts simultaneously. For instance, in such a configuration the audio for the school bell can be heard during announcements. Similarly, for SIP it may be desirable to conference calls together, which provides a better experience than rejecting calls when one is already in progress. In such a configuration, a party can then choose to hang up if they don't wish to be in a conference call.

In some embodiments, the operation of the master speaker 304 may have limited CPU capacity. It will be appreciated that varying levels of CPU power can be incorporated into the master speaker 304 but, for cost effectiveness and providing sufficient CPU power the majority of situations, some embodiments may include the capability to limit functionality based on CPU availability. As a non-limiting example, INFORMACAST broadcasts using high-quality audio (such as 44.1 kHz audio) can consume a considerable amount of the CPU capacity, such as 35% of the CPU capacity as an example. The master speaker 304 can track its CPU usage, and only accept additional calls if its rough estimate of its available CPU indicates that it has sufficient CPU capacity to handle the additional call. Thus, if the master speaker has a CPU processing load that is at or exceeds a specific threshold, further requests that would require additional CPU processing can be denied or queued for later processing. In other situations, a current task may be parked, put on hold or canceled to create CPU processing bandwidth to service a new request.

If additional INFORMACAST broadcasts are started and master speaker 304 cannot accept any more broadcasts (e.g. because it doesn't have enough CPU capacity remaining, or because the INFORMACAST account was configured with a low number of allowed simultaneous broadcasts), the new broadcasts are “parked” (put on hold) and are not played. When one of the active broadcasts ends, if there are any parked broadcasts, they can be unparked (taken off hold) in the order they were received until all parked broadcasts are playing or there aren't enough CPU capacity to unpark the remaining parked broadcasts.

(d) Dual Registration

Some embodiments of the master speaker 304 can be “dual registered” as both an INFORMACAST speaker and a SIP endpoint. In such embodiments, the master speaker 304 maintains active registrations/accounts with both services simultaneously. When supporting dual registration, the master speaker 304 can receive an incoming call from either the INFORMACAST audio broadcast or the SIP call services.

It is expected that situations would arise in which an INFORMACAST audio broadcast and a SIP call might occur simultaneously. Including the ability to handle this situation may significantly increase the cost of the SCS. Thus, in some embodiments, this scenario is handled by only allowing one type of simultaneous call. Thus, if an INFORMACAST broadcast audio session is active at the time of receiving a SIP call request, the SIP call request can be filtered or ignored. Likewise, if a SIP call is active at the time of receiving an INFORMACAST broadcast audio request, the INFORMACAST broadcast audio request can be filtered or ignored. In a situation in which an INFORMACAST broadcast audio request and a SIP call request are received at the same time (realizing that the two requests would actually be received serially but the concept of “being received at the same time” refers to having received both request prior to setting up a session for either of the requests) the various embodiments may be configured to respond differently, either by hard coding or software configuration. For instance, the SCS can be configured to give preference to the request that arrives first or, the system can be configured to give preference to one over the other. Further, in some embodiments, a user may even have the opportunity to select which request to accept.

It should also be appreciated that some embodiments may be configured to handle both types of calls simultaneously. For instance, some embodiments of the SCS may simply conference the audio of these two call types together. Several complexities can arise in this situation and the various embodiments may be configured to handle these complexities in different manners. For instance, without further processing, simply mixing the SIP and INFORMACAST broadcast together, the local and remote parties on the SIP call would have to speak loudly to be heard over the INFORMACAST broadcast. Alternately, the INFORMACAST broadcast could be played locally but not audible to the remote party, in which case the remote party would continue talking unaware that their speech may not even be intelligible over top of the INFORMACAST audio broadcast. Further, if the SCS is operating in half-duplex, the local party would be unable to speak to the remote party because the INFORMACAST audio would prevent the master speaker 204 from unmuting the microphone.

It should be appreciated that each of these complexities could be overcome by providing additional processing of the signals. For instance, in some embodiments, priority can be given to an INFORMACAST broadcast. Thus, if an INFORMACAST broadcast is received during a SIP call, the SIP call can be muted during the INFORMACAST broadcast. Likewise, if a SIP call is received during an INFORMACAST broadcast, priority can be given to the SIP call by muting the INFORMACAST broadcast. In the later example, the SCS may buffer the INFORMACAST broadcast and then continue the delivery upon the termination of the SIP call. In some embodiments, a user may be able to manually select which call to give priority to on a case-by-case basis. In addition, they CSC system can simply operate in accordance with the user activity. For instance, if an INFORMACAST broadcast is currently active when a user attempts to make a SIP call, the CSC can give preference to the SIP call under the assumption that the user would not be attempting to place the SIP call during the INFORMACAST broadcast if it was not important enough to do so. Further, the CSC system may simply prevent INFORMACAST broadcast to interrupt a SIP call of one party in a scenario in which other parties that are not in a SIP call will receive the broadcast and can inform the other party.

Further, the types of calls can be categorized with priority levels. While the current deployment of INFORMACAST may not support such granularity, it is anticipated that future versions may, as well as other existing or developed protocols. As a non-limiting example, a SIP call with a teacher having an innocuous conversation with the front office could be canceled if INFORMACAST needs to play an urgent tornado warning. Conversely, an INFORMACAST broadcast of the lunch menu cold be interrupted if a teacher needs to make a SIP call to report a student having a medical emergency.

Thus, a high priority SIP call may trump an active INFORMACAST broadcast while a low priority SIP call may be rejected. Likewise, a high priority INFORMACAST broadcast may trump an active SIP call (for instance for an emergency alert) while a lower priority INFORMACST broadcast may be ignored during an active SIP call. Those skilled in the art will recognize that other processing can also be employed for such scenarios.

(e) Multicast Audio

As previously mentioned, embodiments that are deployed within an INFORMACAST or similar protocol environment are only exemplary embodiments. Some embodiments may operate in a simple multicast audio environment that does not include signaling.

Such embodiments are particularly suitable for environments such as a warehouse, factory, hotel, etc. The smart speaker 304 can be configured to receive (or listen) to multiple broadcasts and filter them in accordance with priorities. As a non-limiting example, the smart speaker 304, or the master controller 302 can be configured to listen to up to 6 multicast audio streams that are prioritized from high to low. SIP calls may be assigned a medium priority, so that in this example, there is a total of 7 priority levels:

Multicast stream, highest priority (e.g. emergency paging)

Multicast stream, second highest priority

Multicast stream, third highest priority

SIP calls

Multicast stream, third lowest priority

Multicast stream, second lowest priority

Multicast stream, lowest priority (e.g. background music)

In operation, the exemplary embodiment, when multicast streams are enabled and configured, the device plays the highest priority audio source that's in use. This allows for a variety of uses such as background music (idle audio), simple paging and announcements, and emergency paging/broadcasts. Higher priority audio sources interrupt lower-priority ones temporarily. After the higher-priority audio source becomes idle again (i.e., multicast stream has been silent for a configurable period of time such as a few seconds, tens of seconds or even sub-second, or SIP calls have been hung up), the next-highest priority audio source is resumed.

(1) Panic Button

Various embodiments of the master speaker 304 may interface to a panic button. The panic button operates as an extension of the sensors/detectors 320 in that it is a human triggered event of a potential threat that is perceived of by a human rather than the sensors/detectors. In operation, when the panic button 312 is actuated, the master speaker 304 receives a signal or, detects the closing of a current loop or a control line being grounded or raised to a particular voltage level, etc. In response, the master speaker 304 can then initiate an action in response to the actuation. The actions may include any of a variety of actions such as turning on all of the sensors/detectors 320, actively monitoring the vicinity of the panic button, sounding an alarm in the particular room or vicinity of the panic button, sounding an alarm throughout the system, sending a message to the master controller 302 to take action, such as sounding an alarm, playing an announcement, placing a SIP call to the classroom to obtain further details, opening an INFORMACAST connection to request further information, placing a call to authorities, etc. Similarly, the master speaker 304 may initiate a SIP call or INFORMACAST conference to a party at the master controller 301 or to authorities. It should also be appreciated that the panic button may be more than just a simple Boolean type actuation (i.e., actuated or not actuated). The master speaker 304 may be configured to detect multiple type of actuations such as three short actuations, followed by three long actuations, followed by three more short actuations (Morse code for SOS) as well as other sequences. Further, the panic button may be a smart panel that includes multiple buttons and sensors and sends a particular signal for each button or combination of buttons or sensor.

In one exemplary embodiment, when the panic button is actuated for a short period of time, the master speaker 304 may initiate an emergency SIP call to a first URI, such as the controller for the master controller 302. When the panic button is actuated for a prolonged period of time, the master speaker 304 may initiate a SIP call to a different configurable URI, which may be someone prepared to handle an emergency.

In the exemplary embodiment, both types of calls may be considered “emergency” calls. When an emergency call is placed, any lower-priority calls or broadcasts on the master speaker 304 can be parked so that the emergency call becomes the only active call. When the emergency call is hung up, any parked calls or broadcasts get unparked.

Short-press emergency calls are higher-priority than all other calls, but lower priority than long-press emergency calls. This means a short-press call interrupts normal (non-emergency) calls, but not short-press or long-press emergency calls. Long-press emergency calls are the highest priority call in the system. This means a long-press emergency call interrupts all other types of calls, including short-press emergency calls, but not other long-press emergency calls.

Further, the exemplary embodiment can be configured such that emergency calls cannot be hung up locally (from master speaker 304). Rather, the emergency calls can only be hung up by the peer after being answered. Further, a short-press emergency call could be hung up by master speaker 204 in order to respond to a long-press and thus, place an emergency call. Emergency calls ring until answered, or until a SIP Timer terminates the call after a period of time, such as 3 minutes a non-limiting example, due to it not being answered.

(g) Relays

The master speaker 304 may be equipped with one or more single pole, double throw relays for controlling auxiliary devices. The relays can be controlled by the master controller 302 sending commands to the master speaker 304 and/or in response to the master speaker 304 detecting other activity and controlling the relays directly. For instance, in response to receiving a panic actuation from one master speaker, the master controller 302 can send a command to each of the master controllers, or a subset of the master controllers in the system to trigger one or more relays. In addition, due to other circumstances, such as an alert from authorizes, by action of an operator of the master controller 302, or other activity, the master controller 302 can send commands to trigger one or more relays of one or more master controllers. Further, in response to detecting smoke, excessive heat, actuation of a panic button, etc., the master controller 304 may trigger one or more of its own relays and/or send a signal to the master controller 302 regarding the detected activity.

The relays can be utilized to control various devices, such as door locks, flashing emergency lights (blue lights), releasing fire doors to be closed, changing the time on a clock, engaging window blinds (such as exterior window blinds to prevent glass breakage during high wind or tornado activity, turning on emergency lights, etc. During an emergency, the relays would be used to activate the door locks (forcibly locking the door to prevent entry or exit) and/or activate the flashing emergency lights. In the illustrated embodiment, the relays are shown as controlling door1 308, door2 310 as well as other controllers 314.

The master speaker 304 registers its relays with the master server 302, such as by registering them as GPIOs under an INFORMACAST protocol. The server controller then operates to send commands to the master speaker directed to the registered GPIOs in order to switch the relays. Thus, in some embodiments, only the master controller can operate the relays while in other embodiments, the master controller and/or the master speakers can operate the relays. In addition, in some embodiments the panic button can be used to manually trigger the master speaker to operate the relays, such as using a particular actuation sequence as a non-limiting example.

(h) Wall Plate (Front Panel)

In an exemplary embodiment, the master speaker 304 can be a Wahsega 2×2 ceiling tile IP speaker that is equipped with an analog speaker and internal microphone. In such an embodiment, the master speaker includes an RJ45 connector for receiving a Cat5/6 cable that can be connected to an optional wall plate that serves as the front panel for the master speaker 304. At least three types of wall plates can be interfaced to the master speaker 304: “sound reinforcement only”, “mic only”, and “sound reinforcement and mic”. The “sound reinforcement” wall plates have an audio input jack (e.g. a 3.5 mm miniplug), a button to start/stop sound reinforcement, an LED to indicate when sound reinforcement is enabled and a volume control knob. The “mic” wall plates may include a microphone 306, a button to place or accept a call, and an LED to indicate when the microphone is in use. The illustrated wall plate 330 is shown as including both the audio jack for sound reinforcement 332 and the microphone 306. In some embodiments, the wall plate 330 may also include a local speaker.

When a wall plate with the microphone and call button is installed, the microphone within the wall plate can be used instead of the internal (ceiling) microphone. The “call” button operates as a standard intercom button. Actuating the button while the device is idle (not playing any INFORMACAST broadcasts, although it may be playing multicast streams since those count as “idle”) initiates a SIP call to a configurable URI. Unlike the “panic” button, this button doesn't terminate existing calls or broadcasts. Instead it follows the normal rules for accepting new SIP calls based on the configuration of the system. For instance, in one embodiment described above, the actuation will only initiate a SIP call if there are no calls/broadcasts or if there are only SIP calls in progress. Actuation of the “call” button while a SIP call is already in process can be configured to either do nothing or to hang up the call. Further, pressing the button while an incoming SIP call is ringing can be configured to answer the call.

The wall plates that include sound reinforcement include hardware for “sound reinforcement”. Sound reinforcement may consist of an audio input jack (e.g. a 3.5 mm miniplug), a button to enable sound reinforcement and/or a volume control knob. To invoke the sound reinforcement, a user connects the audio output of a device (such as a wireless microphone receiver, a smart phone or a DVD player) into the wall plate's audio input jack, and pressing the button to turn on sound reinforcement. When sound reinforcement is on, the audio from the device plugged into the input jack is played over the master speaker, and the sound reinforcement LED is lit. Pressing the button again turns off sound reinforcement. It should be appreciated that sound reinforcement can be activated by the button, as previously described or by detecting that the jack has been inserted.

In some embodiments, sound reinforcement can be set as the lowest priority type of audio. When any other audio, such as INFORMACAST broadcast audio and/or SIP calls is being received in such an embodiment, the sound reinforcement is temporarily disabled so that the audio from the broadcast or SIP call can be heard. When all calls are finished, sound reinforcement resumes as normal (returning to its on/off state from before the call). It should be understood that in some embodiments, the sound reinforcement may receive priority. For instance, in a classroom setting, if the sound reinforcement is being used to administer a test, the user may want to prevent interruptions from the INFORMACAST broadcast audio. Thus, some embodiments may be configured to set the sound reinforcement as high priority, enable a user to selectively adjust the priority, or implement emergency broadcasts that can interrupt the sound reinforcement but prevent other audio broadcasts or SIP calls from interrupting the sound reinforcement. Other configurations are also anticipated for changing and setting the various priorities.

(i) Event Detection

The event detection can be as simple as monitoring the sound that can be picked up by the microphones, such as the microphone in the ceiling tile speaker and wall plate in the afore-described exemplary embodiment. However, in more sophisticated embodiments, arrays of sensors of multiple types can be deployed, such as within a single class room or throughout the entire facility. The events can be analyzed, threats ascertained and remedial measures triggered all by the sensors in one embodiment or, in other embodiments, signals can be sent to the master speaker 304 and/or master controller 302 for analysis, remedial measures, etc.

(j) Current Limiting

Typically, if a device is drawing too much current from a PoE, the PoE supply equipment can cut off all power to the port. To prevent this from occurring, the master speaker 304 may include a component for detecting an overcurrent situation. If the master speaker 304 determines that it is drawing too much current, it can then take appropriate measures to limit the current, such as by lowering the volume temporarily, parking an audio broadcast or SIP call, etc.

(k) Status Light and RTFM Button

The master speaker 304 can be equipped with a status light 352 and a RTFM 354 (Reset Test Function Management) button. When the master speaker 304 first boots up, the status light enters into a slow blink state. This state indicates that the master speaker 304 is attempting to obtain an IP address. After the master speaker obtains an IP address, the status light can change to a fast blinking state. The fast blinking state indicates that the master speaker is attempting to register with INFORMACAST server(s) or master server 302. After the master speaker 304 is registered, the status light can be changed to a steady on state. The steady on state can be used to indicate that the master speaker 304 is working normally and can play INFORMACAST broadcasts and receive/place SIP calls.

The RTFM button can be configured for other purposes also. For instance, in some embodiments, the RTFM button can be configured to reformat the file system if it is held down or actuated when power is applied to the master speaker 304 or an on switch is actuated. In addition, or alternatively, the RTFM button can be configured to reset only the network configuration to a default setting but maintain other configuration settings if it is actuated for a particular period of time. Further, the RTFM button can be configured to reset all configuration settings to a default state if it is actuated for a different period of time. It should be appreciated that many other settings may also be implemented such as actuating the button a particular number of times over a specified period, etc.

(2) Single Room, Multiple Speakers Playing the Same Audio

(a) Single Room with Multiple Analog Speakers

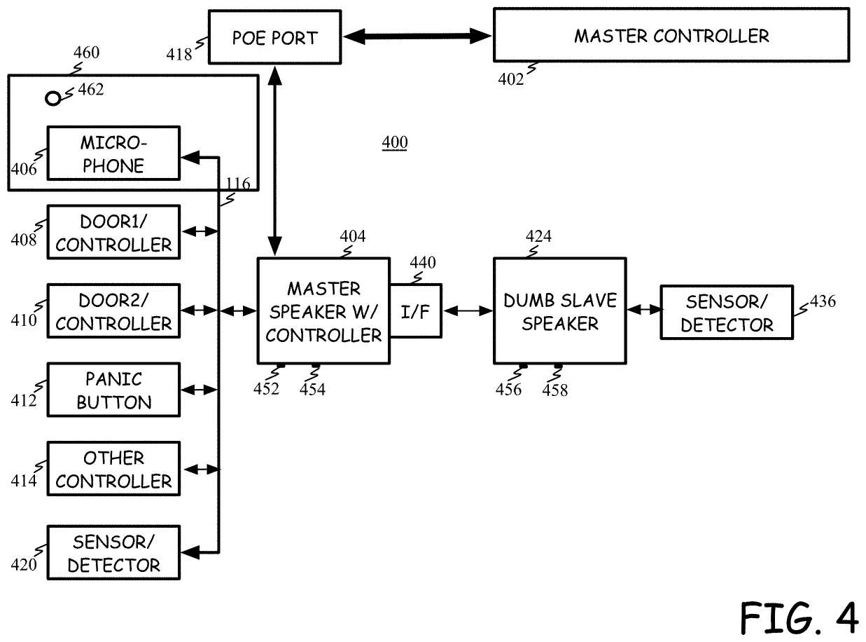

FIG. 4 is a block diagram illustrating the single room deployment of embodiments of the SCS with multiple speakers. This single room with multiple speakers (or IP Loads) deployment includes all of the features described in relationship to the single room single speaker deployment and thus, the afore-described features will not be presented again but rather, will simply be referenced in this section.

In the illustrated configuration, the master controller 402 interfaces to one or more deployed systems 400 thorough a PoE port 418. The illustrated deployed system includes a master speaker 404 and a dumb slave speaker 424. The master speaker 404 interfaces to the dumb slave speaker 424 through an interface/controller 440. The dumb slave speaker 424 includes an internal analog speaker that is driven by the dumb slave speaker 424 but, the dumb slave speaker 424 may not include a microphone or other sensor but, in some embodiments it can include one or more. It should be appreciated that although only one dumb slave speaker 424 is illustrated, multiple slave speakers may also be driven by the master speaker 404. Obviously, there is a limitation on the number of slave speakers that can be driven as the Poe 418 is current limited. However, it will be appreciated that other interface ports and improvements on the PoE ports can enable even more slave speaker systems to be driven. Further, it should be appreciated that in some embodiments, the slave speakers may be powered by another system, such as being wired directly to a power source or may include batteries.

The main enhancement in the single room, multiple speaker deployment is that the audio that is sent to the master speaker 404 is also sent to the dumb slave speaker 424 by the interface controller 440 and, events detected by the sensors attached to the dumb slave speaker 424 as well as to the master speaker 404 can be received.

Another enhancement in the deployed system 400 that can be realized is full-duplex operation. The cost associated with implementing the full-duplex operation can be simplified by using the microphone within the master speaker 404. Further, the audio delivered to the room can be sent to the dumb slave speaker 424 while the analog speaker in the master speaker 404 can be muted. Advantageously, this configuration can prevent the feedback that can occur in a full-duplex system simply be having the microphone and the speaker separated.

In the illustrated deployed system 400, the master speaker 404 and the dumb slave speaker 424 may have the same volume controller, different volume controllers or, a volume controller that can be configured to be joined in tandem or operated independently.

The master speaker 404 includes volume controls for the analog speaker (volume/gain) as well as volume/gain for the microphone, noise suppression and a high-pass filter. These features may be common to not only this deployment but also to each of the other embodiments described herein. The dumb slave speaker 424, which only includes an analog speaker, on requires volume control (volume/gain) for the analog speaker. Separate volume control for each speaker is often desirable to suit various room configurations. For instance, in a sloped lecture hall where the rear ceiling speakers are closer to the audience than the front ceiling speakers, the rear speakers might be set to a lower volume. Conversely, in a lecture hall where the presenter is using a wireless microphone for sound amplification, the front speakers may be quieter to avoid feedback.

(b) SIP Endpoint

Similar to the description in connection with FIG. 3, at startup, the software operating in conjunction with the master speaker 404 reads configuration stored in its nonvolatile memory and prepares itself as a SIP endpoint (either by registering with its configured SIP server, or by preparing itself as a peer-to-peer SIP endpoint without registration). No further configuration changes are necessary for the dumb slave speaker 424 during this registration process as the master controller and the system are unaware of the presence of the dumb slave speaker 424.

(c) Multiple Calls

Similar to the deployment presented in FIG. 3 and described herein, the master speaker 404 can be configured to allow multiple simultaneous calls. As such, the functions, components and capabilities presented above equally apply in this deployment.

(d) Dual Registration

Similar to the deployment presented in FIG. 3, embodiments of the master speaker 404 can be “dual registered” as both an INFORMACAST speaker and a SIP endpoint. As such, the functions, components and capabilities presented above equally apply in this deployment. However, in the deployed system 400, an additional capability can be realized in the handling of multiple calls. For instance, in some embodiments of this deployment, if an INFORMACAST audio broadcast and a SIP call occur simultaneously, the audio associated with the different calls can be sent to different speakers and the volume for each can be independently controlled. Advantageously, this embodiment would allow entities in one part of the room to hear the INFORMACAST audio broadcast while entities at another part of the room can hear the SIP call.

(e) Multicast Audio

Similar to the deployment presented in FIG. 3, embodiments of the deployment presented in FIG. 4 may also support the multicast audio features.

(f) Panic Button

Similar to the deployment presented in FIG. 3, embodiments of the deployment presented in FIG. 4 may also support a panic button 412 connected to the master speaker via a direct connect 416, a bus, a wireless technology, etc. As such, the description of the panic button in connection with FIG. 3 is also applicable to this the embodiments of the deployment presented in FIG. 4.

(g) Relays

Similar to the deployment presented in FIG. 3, the master speaker 404 may be equipped with one or more single pole, double throw relays for controlling auxiliary devices. In the illustrated embodiment, the relays are shown as controlling door1 408, door2 410 as well as other controllers 414, but it will be appreciated that any number of relays can be utilized in the various embodiments to control any of a variety of types of devices and the ones presented herein are simply provided as non-limiting examples.

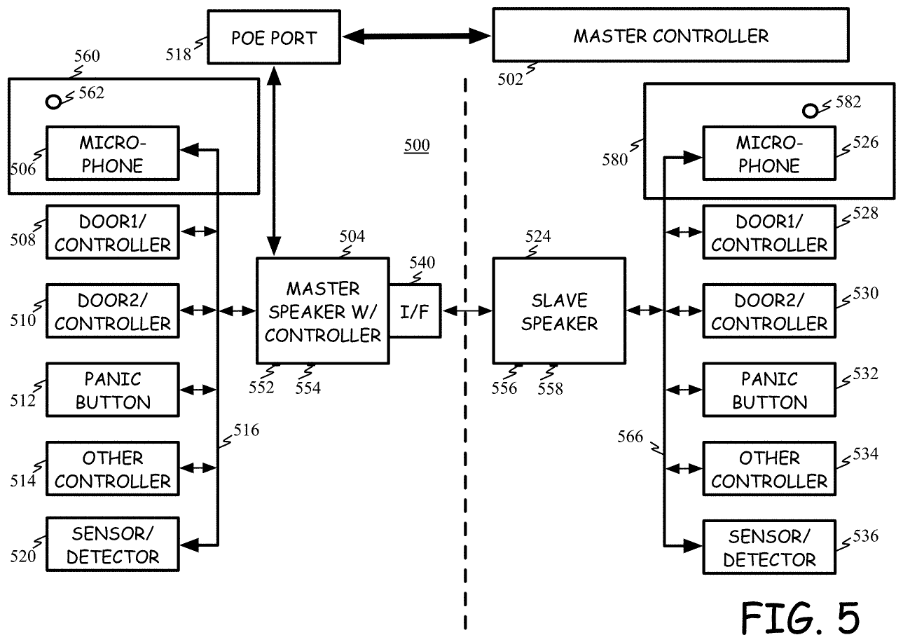

As such, the description presented in connection with FIG. 4 applies as well to the deployment presented in FIG. 5.

(h) Wall Plate (Front Panel)

Similar to the deployment presented in FIG. 3, the embodiments of the deployment in FIG. 4 may include an optional wall plate 460 that serves as the front panel for the master speaker 404 and, also operates to control the dumb slave speaker 424 through the master speaker 404. As such, the features and functionality presented in the description of FIG. 3 also apply to FIG. 4. However, it should be appreciated that in some embodiments, a separate sound reinforcement jack may be provided for the master speaker 404 and the dumb slave speaker 424.

(i) Event Detection

Similar to the deployment presented in FIG. 3, the embodiments of the deployment in FIG. 4 may include event detection, which may be as simple as monitoring the sound that can be picked up by the microphones, such as the microphone in the ceiling tile speaker and wall plate in the afore-described exemplary embodiment. However, in more sophisticated embodiments, arrays of sensors of multiple types can be deployed, such as within a single class room or throughout the entire facility. The events can be analyzed, threats ascertained and remedial measures triggered all by the sensors 420 and 436 in one embodiment or, in other embodiments, signals can be sent to the master speaker 404 and/or master controller 403 for analysis, remediation, etc.

(j) Current Limiting

Similar to the deployment presented in FIG. 3, the embodiments of the deployment of FIG. 4 may include current limiting to prevent the PoE from cutting off all power to the port or the master speaker 404. However, it should be appreciated that the dumb slave speaker 424 may include its own power source by plugging into an outlet or direct wiring, or even include battery power.

(k) Status Light and RTFM Button

In an exemplary embodiment, the dumb slave speaker 424 may include a similar status light 456 and RTFM button 458 as the master speaker 404 (452 and 454 respectively). In some embodiments, the status light may be a different color (i.e. yellow) so the master speaker 404 and the dumb slave speaker 424 can be visually distinguished. In some embodiments the state status light of the dumb slave speaker 424 can mirror the state of the master speaker 404. In other embodiments, the status may be decoupled to independently provide a status indication for each speaker system. Further, in some embodiments the RTFM button 458 on the slave speaker can be disabled, while in other embodiments it may be functionally and/or physically tied to the RTFM button 454 of the master speaker 404. In these embodiments, the entire system is controlled by the actuation of the RTFM button 454 or either of the RTFM buttons 454 or 458 depending upon the configuration. Further, the RTFM button 454 and 458 may operate independent of each other and control the speaker system to which they are coupled.

(3) Multiple Rooms/Zones with Each Room/Zone Having a Speaker.

FIG. 5 is a block diagram illustrating the multiple room deployment of embodiments of the SCS. In current state of the art deployments, in setting up multi-room systems, a deployed system similar to system 300 of FIG. 3 or 400 of FIG. 4 are placed in each room. This can be costly in that a PoE line must be run to each room and a fully equipped master speaker must also be deployed in each room. The various embodiments of the deployment presented in FIG. 5 enable a cost savings over the current state of the art by utilizing a single master speaker 504, connected to a master controller 502 through a PoE port 518 hardware specially designed to control the room in which the master speaker is installed, as well as slave speaker 524 located in one or more other rooms independently. This saves on the overall cost because fewer of the more expensive master speakers are utilized, less PoE supply equipment [PSE] is necessary, fewer cable runs are required and less maintenance is needed by IT support departments.

In the various embodiments of the deployment of FIG. 5, the slave speakers 524 in each room have the same functionality and provide the same user experience as the master speaker 504 but, at a great cost savings.

(a) InformaCast Speaker

The various embodiments that take the form of the deployment presented in FIG. 5 basically operate or behave as though multiple master speakers have been deployed. As a non-limiting example, if the master speaker 404 is based on an INFORMACAST speaker, each of the slave speakers 524 in the system also appear to operate as an INFORMACAST speaker. Utilizing the discovered INFORMACAST configuration, the master speaker 504 registers itself multiple times with the InformaCast server(s), once for the master speaker 504 and once for each slave speaker 524. In exemplary embodiments, the master speaker 504 registers using a different MAC address for each speaker (master and slave). The MAC address for the master speaker 504 corresponds to its Ethernet address, as normal. The MAC address for each slave speaker 524 is an otherwise valid MAC address that is not used for any Ethernet communication. Rather, it is only used so the INFORMACAST servers can distinguish the registrations.

The first INFORMACAST registration (using the master speaker's WAN MAC address, the one it uses for all its Ethernet communication) is for master speaker 404. The subsequent INFORMACAST registrations are for the slave speaker 524.

(b) SIP Endpoint

Similar to the embodiments described in connection with FIG. 3, the embodiments for the deployment presented in FIG. 5 may operate to establish the master speaker 504 as a SIP endpoint as well as to establish other SIP accounts for each of the slave speakers 524.

(c) Multiple Calls

Similar to the description presented in connection with the deployment presented in FIG. 3, various embodiments of the deployment of FIG. 5 may include the ability to handle multiple calls. As such, the features presented in connection with FIG. 3 also apply to the embodiments for FIG. 5. However, in the embodiments presented for FIG. 5, the speaker and microphone associated with the master speaker 504 and the slave speaker 524 can operate independently. Thus, a call on the master speaker 504 does not preclude any type of call on any of the slave speaker 524, and vice versa. It will be appreciated that in some embodiments, the audio processing is still performed by the master speaker 504 and as such, the master speaker 504 maintains a combined rough estimate of its CPU usage, and decides to accept or reject additional calls based on that combined estimate.

(d) Dual Registration

Similar to the embodiments presented in connection with FIG. 3, the various embodiments of the deployment illustrated in FIG. 5 may have a master speaker 504 that can be “dual registered” as both an INFORMACAST speaker and a SIP endpoint. In such embodiments, the master speaker 504 maintains active registrations/accounts with both services simultaneously. Similarly to the description presented for FIG. 3, in supporting dual registration, the master speaker 504, as well as each of the slave speakers 524 can receive an incoming call from either the INFORMACAST audio broadcast or the SIP call services. As such, the functions, components and capabilities presented above with regards to FIG. 3 equally apply in this deployment. Also, it will be appreciated that a hybrid deployment can also be utilized. For instance, a deployment may include a master speaker 504 and a slave speaker 524, as illustrated in FIG. 5, as well as a dumb slave speaker, similar to the dumb slave speaker 424 of FIG. 4, that is controlled by the master speaker 504. In such an embodiment, an additional capability can be realized in the handling of multiple calls. For instance, in some embodiments of this deployment, if an INFORMACAST audio broadcast and a SIP call occur simultaneously for either the master speaker 404, the audio associated with the different calls can be sent to different speakers and the volume for each can be independently controlled. Advantageously, this embodiment would allow entities in one part of the room to hear the INFORMACAST audio broadcast while entities at another part of the room can hear the SIP call.

(e) Multicast Audio

Similar to the deployment presented in FIG. 3, embodiments of the deployment presented in FIG. 5 may also support the multicast audio features. However, in the embodiments of FIG. 5, both the master speaker 504 and the slave speaker 524 can support multicast audio.

(f) Panic Button

Similar to the deployment presented in FIG. 3, embodiments of the deployment presented in FIG. 5 may also support a panic button 512 connected to the master speaker via a direct connect 516, a bus, a wireless technology, etc., as well as a panic button 532 connected to the slave speaker 524 via a similar connection 566. As such, the description of the panic button in connection with FIG. 3 is also applicable to the embodiments of the deployment presented in FIG. 5. However, as illustrated in FIG. 5, the slave speaker 524 has its own panic button 532, identical to the panic button 512 that interfaces to the master speaker 504. In an exemplary embodiment, when the panic button 532 is actuated the slave speaker 524 sends a signal to the master speaker 504 to indicate the activity, such as over a UART interface.

The actuation of the panic buttons results in the initiation of a call to location that may be prepared to handle any type of emergency (such as a front office or an actual emergency number [9-1-1]), only one set of emergency numbers is configured. A panic button short press on the panic button 532 of slave speaker 524 will invoke a call to the same URI as a short press on the panic button 512 of the master speaker 504, and likewise for a long press. However, the outgoing call is made from the SIP account for the master speaker 504 or the slave speaker 524 in accordance with which panic button was actuated.

It will be appreciated that the master speaker 504 provides the CPU power for the audio processing of the master speaker 504 audio and audio for each of the slave speakers 524. Thus, in the embodiments for FIG. 5, when an emergency call is initiated for either the slave speaker 524, any current calls that are on the necessary call lines for the slave speaker are hung up (or parked). If there still are insufficient resources to process the emergency call (i.e. insufficient CPU) then calls on other lines are hung up until there are sufficient resources to place the emergency call.

As a non-limiting example, if the panic button 532 is actuated, the master speaker 504 hangs up any calls/broadcasts that are currently on slave speaker 524 audio line. However, the audio line for the master speaker 504 may also have some calls/broadcasts on its line that are consuming too much CPU, a shared resource. If there are not sufficient resources to accept the emergency call from the slave speaker 524, then the calls/broadcasts on master speaker 504 audio line are also terminated until there are sufficient resources to accept the emergency call from the slave speaker.

(g) Relays

Similar to the deployment presented in FIG. 3, the master speaker 504 and each slave speaker 524 may be equipped with one or more single pole, double throw (SPDT) relays for controlling auxiliary devices. The master speaker 504 operates to register the SPDT relays with the INFORMACAST server as part of the registration process. The INFORMACAST server sends commands to operate the relays, which the master speaker 504 turns into UART commands that it sends to the slave speaker 524 instructing it to take the appropriate action to operate a relay. Thus, signals sent to the master speaker 504 can be used to trigger a relay that interfaces with door1 508, door2 510 and the other controller 514. Likewise, commands can be sent to the slave speaker 524 to trigger the relay that interfaces with door1 528, door2 530 and other controller 434.

(h) Wall Plate (Front Panel)

The wall plate 560 for the master controller operates as described in connection with the wall plate 360 as presented in FIG. 3, including microphone 506 and sound reinforcement jack 562. Further, the slave speaker 524 also may include a wall plate 580 with sound reinforcement jack 582 and microphone 526.

The slave speaker 524 may be connected to an RJ45 jack of the master speaker 504 through Cat5/6 cable, as a non-limiting example, which can provide power, line audio, and UART communicatively. The slave speaker 524 can be connected to its wall plate 580 through another RJ45 and Cat5/6 or other cable, similar to how the master speaker 504 is connected to its respective wall plate 560.

The wall plate 580 for the slave speaker 524 and the wall plate 560 for the master speaker 504 may be identical in functionality, hardware, connections and capabilities. However, the two wall plates may differ in implementation. For instance, the slave speaker 524 may simply send and receive UART commands to and from the master speaker 504. As a non-limiting example, the slave speaker 524 may send a command to inform master speaker 504 of a change in its inputs (e.g. button pressed on the wall plate 580, button released, sound reinforcement switch changed position, etc.). In turn, the master speaker 504 can send commands to instruct the slave speaker 524 to changes its outputs (e.g. changing its audio routing or amplification, setting its LEDs, controlling its relays, etc.).

(i) Event Detection

The event detection can be as simple as monitoring the sound that can be picked up by the microphones, such as the microphone in the ceiling tile speaker and wall plate in the afore-described exemplary embodiment. However, in more sophisticated embodiments, arrays of sensors of multiple types can be deployed, such as within a single class room or throughout the entire facility. The events can be analyzed, threats ascertained and remedial measures triggered all by the sensors in one embodiment or, in other embodiments, signals can be sent to the master speaker 304 and/or master controller 302 for analysis, remedial measures, etc.

(j) Current Limiting

Similar to the deployment presented in FIG. 3, the embodiments of the deployment of FIG. 5 may include current limiting to prevent the PoE from cutting off all power to the port or the master speaker 504. However, it should be appreciated that the dumb slave speaker 524 may include its own power source by plugging into an outlet or direct wiring, or even include battery power. In such configurations, the master speaker 504 only is required to monitor the current drain directly associated with what it controls.

(k) Status Light and RTFM Button

In an exemplary embodiment, the slave speaker 424 may include a similar status light 556 and RTFM button 558 as the master speaker 504 (552 and 554 respectively). In some embodiments, the status light may be a different color (i.e. yellow) so the master speaker 404 and the slave speaker 424 can be visually distinguished (for instance, if the two are installed in the same or adjacent room). In some embodiments the state status light of the slave speaker 524 can mirror the state of the master speaker 504. In other embodiments, the status may be decoupled to independently provide a status indication for each speaker system. Further, in some embodiments the RTFM button 558 on the slave speaker can be disabled, while in other embodiments it may be functionally and/or physically tied to the RTFM button 554 of the master speaker 504. In these embodiments, the entire system is controlled by the actuation of the RTFM button 554 or either of the RTFM buttons 554 or 558 depending upon the configuration. Further, the RTFM button 554 and the 558 may operate independent of each other and control the speaker system to which they are coupled.

The “slow blink” (obtaining IP address) status light mode can be the same for both the master speaker 504 and the slave speaker 524, in embodiments in which the master speaker 504 is the only device that obtains an IP address.

The “fast blink” (registering with INFORMACAST server(s)) status light mode may also have transition at different times for the master speaker 504 and the slave speaker 524, as they have separate INFORMACAST accounts.

Likewise, the “steady illumination” state can be entered separately for the master speaker 504 and each of the slave speakers 524 based on the status of its respective INFORMACAST account. For instance, although unlikely, it's possible that the master speaker 504 INFORMACAST account could register but one or more of the slave speaker 524 INFORMACAST accounts could fail, or vice versa. For example, one may have a device-specific configuration file provided by the server which has incorrect information.

It should be appreciated that the control and functionality of the slave speaker 524 can be completely housed in the master speaker 504 and/or the interface controller 540. However, in some embodiments, some or all of the functionality of the slave speaker 524 can be implemented within the slave speaker 524. While it is anticipated that having all of the functionality and control within the master speaker 504 is the most cost effective solution, it is understood that migration of some of the functionality and control may be negligible from a cost perspective or may be optimal from an operational perspective. Thus, the present disclosure is not limited to simply one configuration.

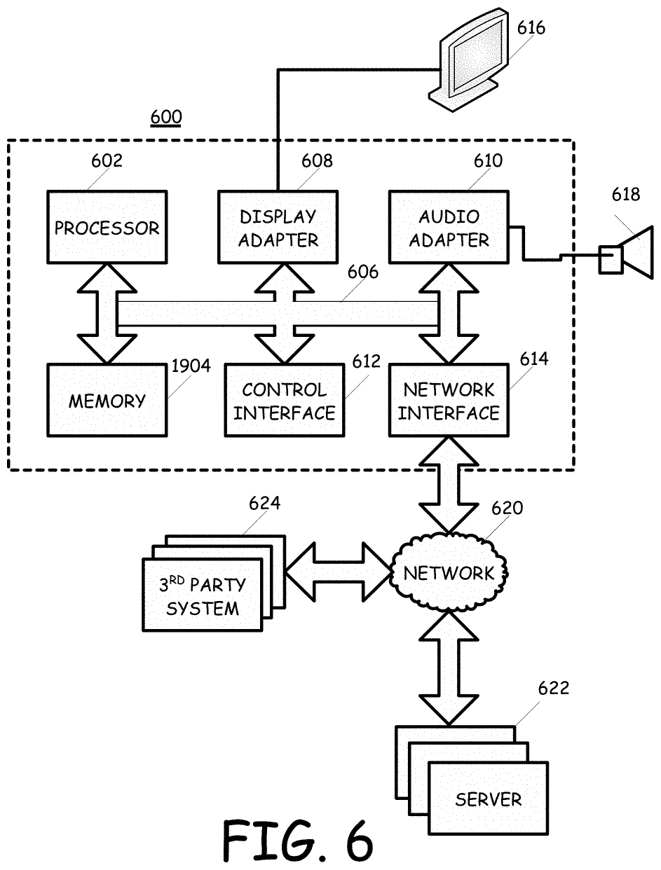

FIG. 6 is a functional block diagram of the components of an exemplary embodiment of system or sub-system operating as a controller or processor 600 that could be used in various embodiments of the disclosure for controlling aspects of the various embodiments. It will be appreciated that not all of the components illustrated in FIG. 6 are required in all embodiments or implementations of a component but, each of the components are presented and described in conjunction with FIG. 6 to provide a complete and overall understanding of the components. Thus, the processing system illustrated in FIG. 6 could be utilized in implementing the master controller, the master speaker, the interface controller and the slave speaker, as well as other components or devices that they may interface with. The controller can include a general computing platform 600 illustrated as including a processor/memory device 602/604 that may be integrated with each other or, communicatively connected over a bus or similar interface 606. The processor 602 can be a variety of processor types including microprocessors, micro-controllers, programmable arrays, custom IC's etc., and may also include single or multiple processors with or without accelerators or the like. The memory element of 604 may include a variety of structures, including but not limited to RAM, ROM, magnetic media, optical media, bubble memory, FLASH memory, EPROM, EEPROM, etc. The processor 602, or other components in the controller may also provide components such as a real-time clock, analog to digital convertors, digital to analog convertors, etc. The processor 602 is also illustrated as optionally interfacing to a variety of elements including a control interface 612, a display adapter 608, an audio adapter 610, and network/device interface 614. The control interface 612 provides an interface to external controls, such as sensors, actuators, SPDT relays, the PSTN, a cellular network, pressure actuators, step motors, a keyboard, a mouse, a pin pad, an audio activated device, as well as a variety of the many other available input and output devices or, another computer or processing device or the like. The display adapter 608 can be used to drive a variety of alert elements 616, such as display devices including an LED display, LCD display, one or more LEDs or other display devices. The audio adapter 610 may interface to and drive another alert element 618, such as a speaker or speaker system, buzzer, bell, etc. The optional network/interface 614 may interface to a network 620 which may be any type of network including, but not limited to the Internet, a global network, a wide area network, a local area network, a wired network, a wireless network or any other network type including hybrids. Through the network 620, or even directly, the controller 600 can interface to other devices or computing platforms such as one or more servers 622 and/or third party systems 624. A battery or power source provides power for the controller 600.

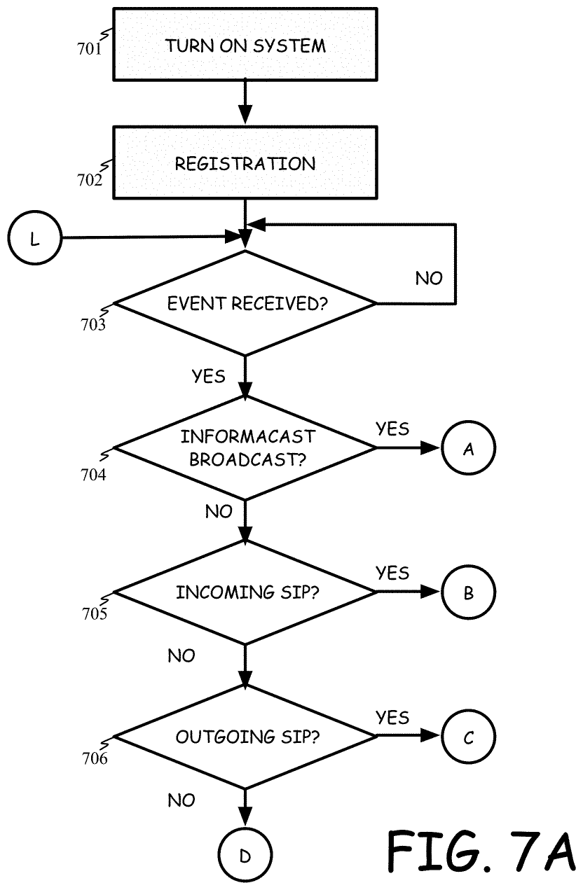

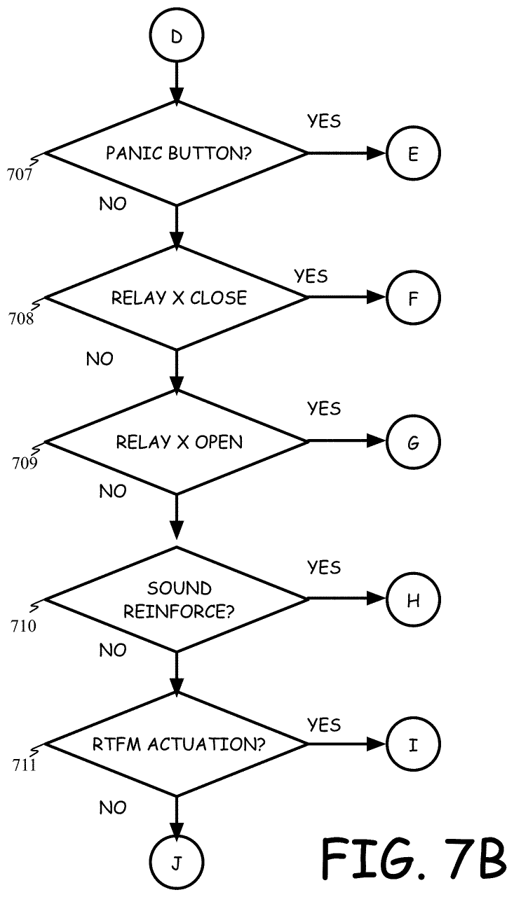

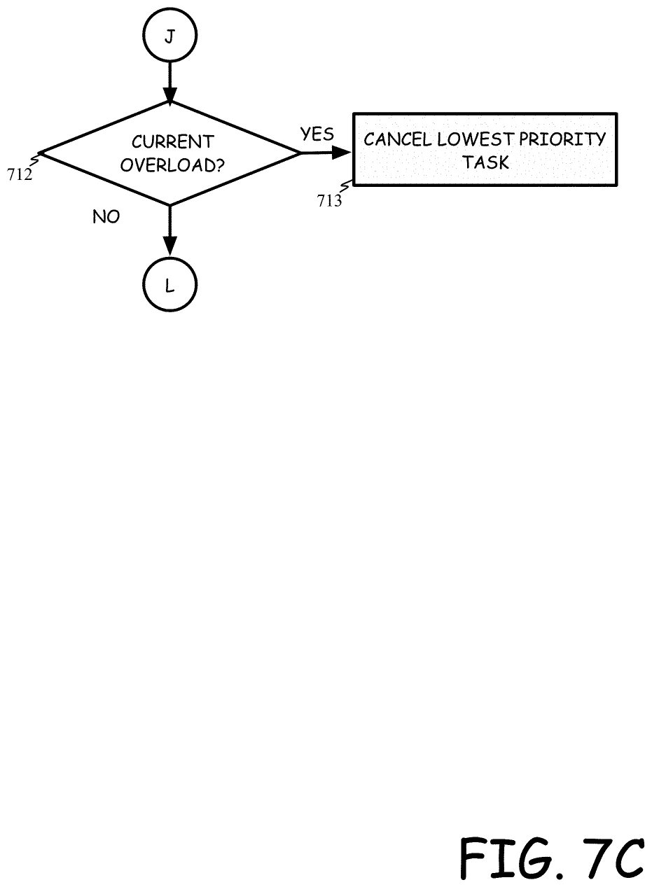

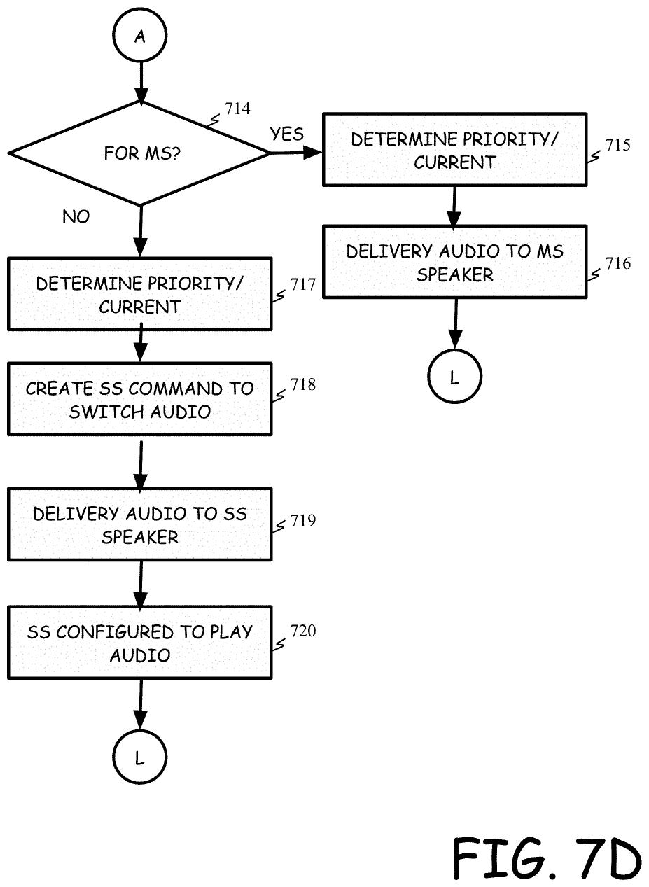

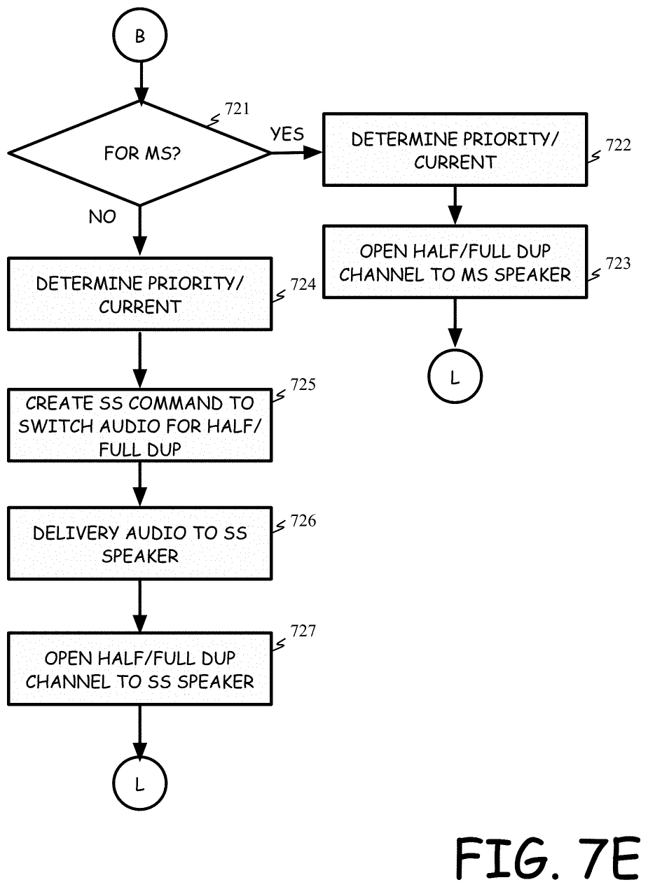

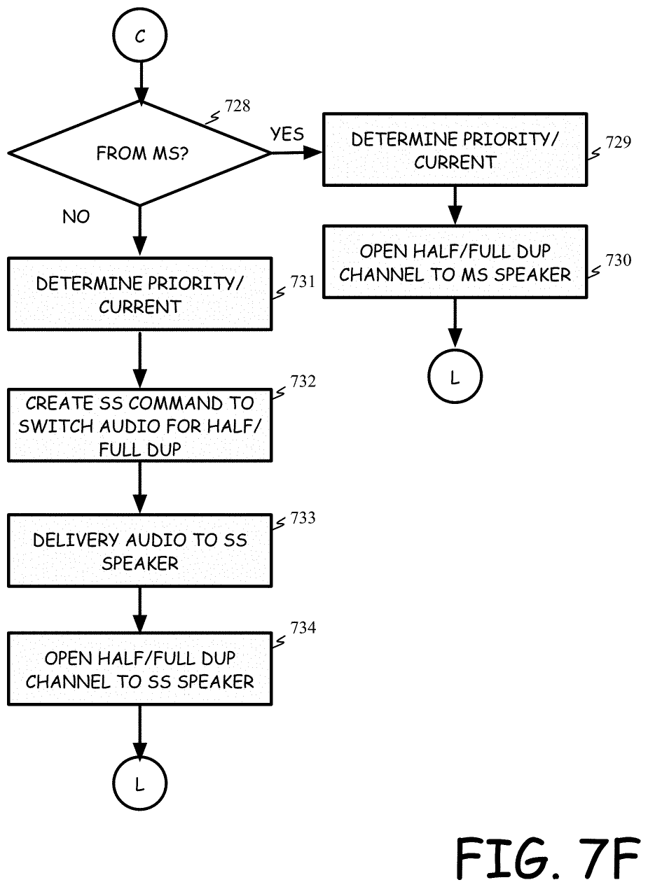

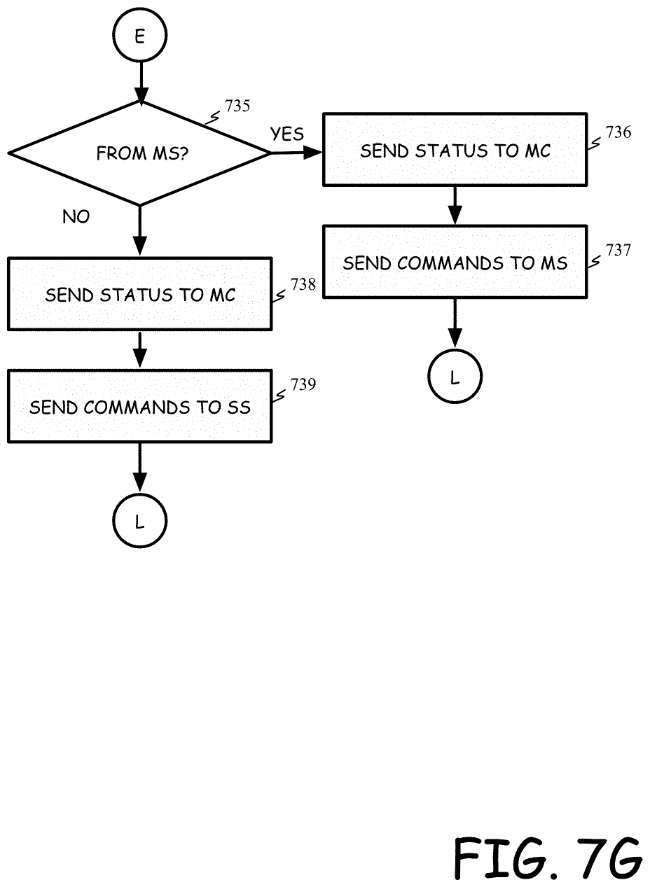

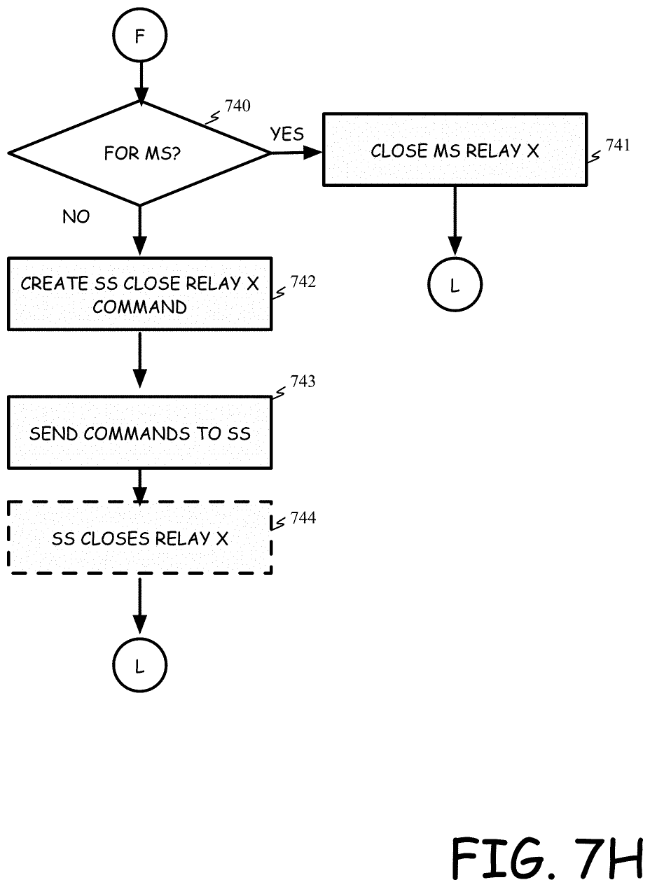

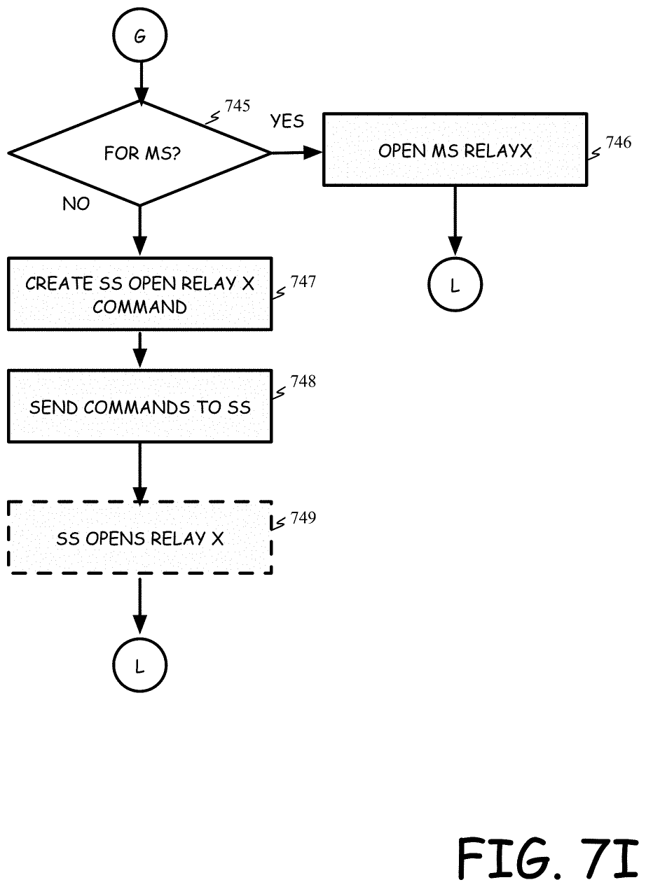

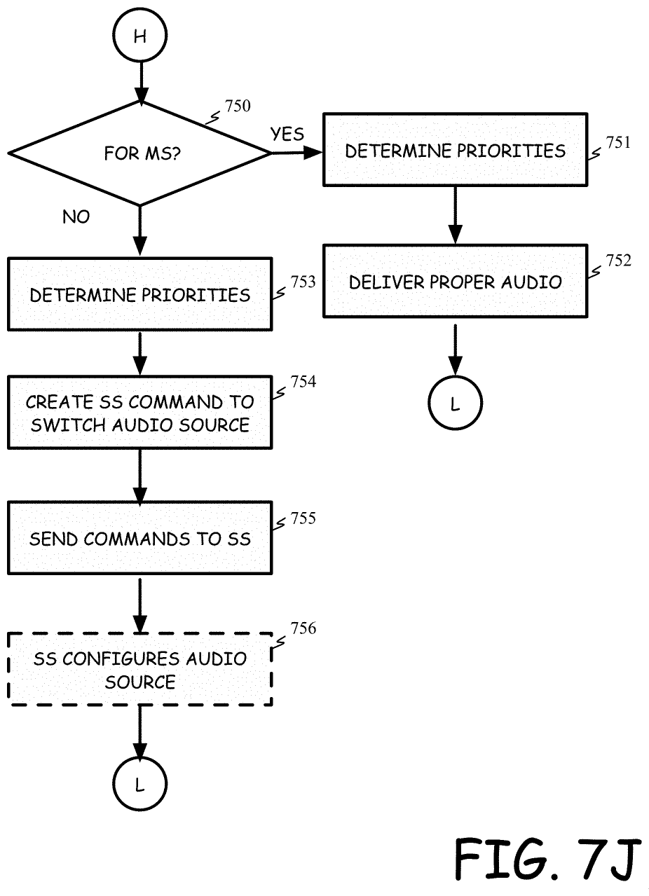

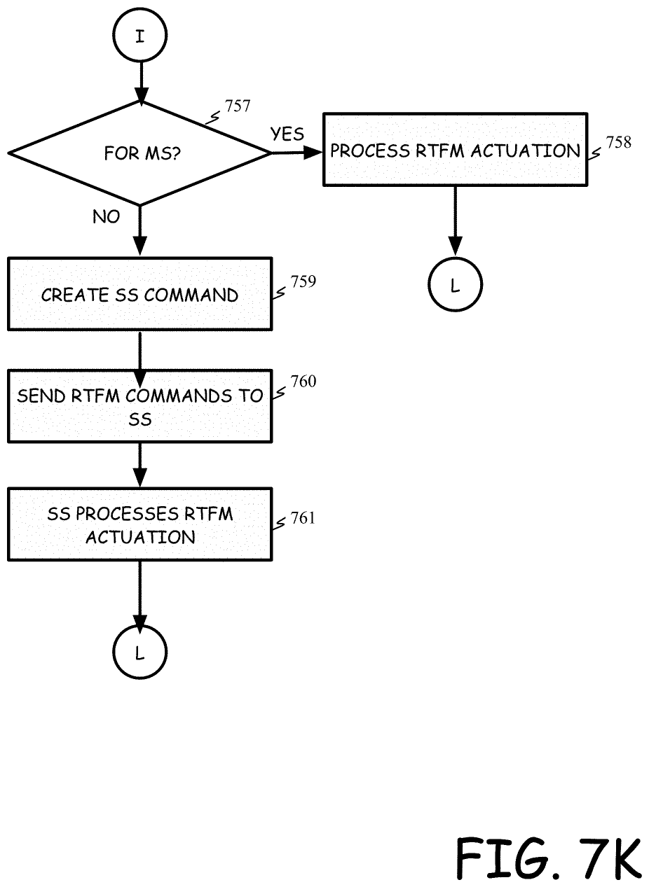

FIG. 7A-FIG. 6K presents a flow diagram to illustrate exemplary steps in a process for establishing and operating an embodiment of a multiple rooms/zones with each room/zone having a speaker as presented in the deployment of FIG. 5. Initially the system is installed by an installer, such as an electrician and each of the components are connected. It should be appreciated that additional components can be added after initial installation but the following processes would be similar. Once power is applied to the system 701, the master speakers go through a registration process 702. This process establishes an IP address for the master speakers and notifies the master controller of the configuration of the master speakers (i.e., what components, capabilities and controls are installed). The slave speakers are also registered. The slave controller boards interface with the slave speakers to identify the configuration and then notifies the master controller.

Once the system is registered, it is read to receive and respond to various events as outlined above. If an event is received 703, processing continues to a series of decision blocks to determine what type of event was received, otherwise, the system may loop back to wait for an event. It should be appreciated that this can be determined in a single step, such as analyzing the scope in an INFORMACAST based system.

If the event is a broadcast event 704, processing continues at point A in FIG. 7D. The broadcast event may be intended for the master speaker or a slave speaker 714. If the broadcast event is for the master speaker, the master speaker determines the priority of the broadcast event in view of any other broadcast events or SIP calls that may be currently active. In addition, the master speaker analyzes the current drawn from the PoE to determine if an additional broadcast can be added to the system 715. Thus, the master speaker may park or cancel one or more current broadcasts and then deliver the audio for the new broadcast to the speaker 716 or, the master speaker may cancel or park the newly requested broadcast. Processing then continues at point L of FIG. 7A.

If the broadcast event is directed to a slave speaker, the controller board receives the event and determines the priority of the broadcast event in view of any other broadcast events and/or SIP calls that may be currently active in the slave speaker 717. In addition, the controller analyzes the current drawn from the PoE by both the master speaker and slave speaker to determine if an additional broadcast can be added to the system 718. Thus, the controller may park or cancel one or more current broadcasts and then deliver the audio for the new broadcast to the slave speaker 719 and the controller configures the slave speaker to play the audio 720 or, the controller may cancel or park the newly requested broadcast. Processing then continues at point L of FIG. 7A.

Returning to FIG. 7A, if the event is an incoming SIP call 704, one that is being sent from the master controller, the processing continues at point B in FIG. 7E. The SIP call may be intended for the master speaker or a slave speaker 721. If the SIP call event is for the master speaker, the master speaker determines the priority of the SIP event in view of any other broadcast and/or SIP calls that may be currently active 722. In addition, the master speaker analyzes the current drawn from the PoE to determine if an additional broadcast can be added to the system 722. Thus, the master speaker may park or cancel one or more current broadcasts and/or SIP calls, and then sets up the master speaker in either full or half duplex mode and delivers the audio for the new SIP call to the speaker 723 or, the master speaker may cancel or park the newly requested SIP call. Processing then continues at point L of FIG. 7A.

If the SIP event is directed to a slave speaker, the controller board receives the event and determines the priority of the SIP event in view of any other broadcast events and SIP calls that may be currently active in the slave speaker 724. In addition, the controller analyzes the current drawn from the PoE by both the master speaker and slave speaker to determine if the SIP call can be added to the system 725. Thus, the controller may park or cancel one or more current broadcasts and SIP calls, and then deliver the audio for the new SIP to the slave speaker 726 and the controller configures the slave speaker to play the audio 727 in either a full or half duplex mode or, the controller may cancel or park the newly requested broadcast. Processing then continues at point L of FIG. 7A.

Returning again to FIG. 7A, if it is determined that the event is an outgoing SIP call, which is a SIP call initiation originating from either the wall panel connected to the master speaker or the wall panel connected to a slave speaker. Processing then continues at point C in FIG. 7F. If the SIP call originates from the master speaker wall panel, then the master speaker determines the priority of the SIP call in view of currently active broadcasts and/or SIP calls 729 as well as conducting a current draw analysis. If the call can be supported, the master speaker sets up the call in either full or half duplex operation 730. Processing then continues at point L of FIG. 7A.

If the SIP call originates from a slave speaker, the slave speaker sends a command to the controller board and the controller board determines the priority of the SIP call in view of currently active broadcasts and/or SIP calls 731 as well as conducting a current draw analysis. If the call can be supported, the controller board creates a command to be sent to the slave speaker 732. The command basically instructs the slave speaker to be configured to receive the call in either full or half duplex mode. Once the slave speaker is set up, the audio is delivered to the slave speaker 733 and the slave speaker then operates in full or half duplex mode 724. Processing then continues at point L of FIG. 7A.

Returning again to FIG. 7A, processing continues at point D in FIG. 7B. If the event is an actuation of a panic button 707, processing continues at point E of FIG. 7G. The panic button may be one connected to the master speaker or a slave speaker. If the panic button is connected to the master speaker, the master speaker determines what type of an actuation occurred (i.e., the system may be configured to distinguish between long and short actuations as well as multiple actuations). A status is then sent to the master controller 736. In response, the master controller sends one or more commands to the master speaker, as well as potentially other master and slave speakers in the system in response to the particular type of panic actuation that occurred 737. For instance, in one embodiment the master controller may send a relay close command to all master and slave speakers in the system to cause the doors in a classroom to be locked. Processing then continues at point L of FIG. 7A.

If the panic button is connected to a slave speaker, the controller board receives a signal from the slave speaker regarding the type of actuation that has occurred and the controller sends a status to the master controller 738. In response, the master controller sends one or more commands to the master speaker, as well as potentially other master and slave speakers in the system in response to the particular type of panic actuation that occurred 739. For instance, in one embodiment the master controller may send a relay close command to all master and slave speakers in the system to cause the doors in a classroom to be locked. Processing then continues at point L of FIG. 7A.

Returning again to FIG. 7B, if the event is a close relay X event 708, processing continues at point F of FIG. 7H. If the command is addressed to the master speaker 740, the master speaker determines which of the relays the command is associated with and then operates to close the appropriate relay 741. A status signal may then be sent to the master controller to confirm such action. Processing then continues at point L of FIG. 7A.

If the command is addressed to a slave speaker, the controller board then creates a command to be sent to the slave speaker 742. The command will include the identification of which relay is to be closed. The command is then sent to the slave speaker 743 and the slave speaker operates to close the appropriate relay 744. A status signal may be sent to the controller board to confirm such action. Processing then continues at point L of FIG. 7A.

Returning again to FIG. 7B, if the event is an open relay X event 709, processing continues at point G of FIG. 7I. If the command is addressed to the master speaker 745, the master speaker determines which of the relays the command is associated with and then operates to open the appropriate relay 746. A status signal may then be sent to the master controller to confirm such action. Processing then continues at point L of FIG. 7A.

If the command is addressed to a slave speaker 745, the controller board then creates a command to be sent to the slave speaker 747. The command will include the identification of which relay is to be open. The command is then sent to the slave speaker 748 and the slave speaker operates to open the appropriate relay 749. A status signal may be sent to the controller board to confirm such action. Processing then continues at point L of FIG. 7A.

Returning to FIG. 7B, if the event is a sound reinforcement event 710, processing continues at point H of FIG. 7J. If the sound reinforcement event is triggered by inserting a jack and/or actuating a switch on the wall panel connected to the master speaker 750, the master speaker determines the priority of the event in view of currently active broadcasts and/or SIP calls 751 and then configures the master speaker accordingly and, if allowed delivers the audio to the speaker of the master speaker 752. Processing then continues at point L of FIG. 7A.

If the sound reinforcement event is triggered by inserting a jack and/or actuating a switch on the wall panel connected to the master speaker 750, the controller determines the priority of the event in view of currently active broadcasts and/or SIP calls 753. If the sound reinforcement is allowable given the current state of priorities and current draw, the controller creates a command to be sent to the slave speaker to configure it for delivery of the audio source 754. The command is then sent to the slave speaker 755 and the slave speaker is configured to present the audio source 756. Processing then continues at point L of FIG. 7A.

Returning to FIG. 7B, if it is determined that the event is an actuation of the RTFM switch 711, then processing continues at point I in FIG. 7K. If the RTFM actuation is associated with the master speaker 757, then the master speaker can determine what type of actuation occurred and process the event accordingly 758. Processing then continues at point L of FIG. 7A.

If it is determined that the actuation of the RTFM switch is associated with the slave speaker 757 (assuming that the configuration allows the slave speaker RTFM to be active), a signal is sent to the controller board which then analyzed the type of actuation and creates an appropriate command to be sent to the slave speaker. It should be appreciated that actuation of the master speaker RTFM may result in sending a command to the slave speaker and vice versa. Processing then continues at point L of FIG. 7A.

Returning again to FIG. 7B, processing then continues at point J of FIG. 7C. If it is determined that the event is a current overload 712 (i.e., the current drawn by the master speaker and any attached slave speakers exceeds a particular threshold, then the master speaker, in conjunction with the controller board may cancel or park lower priority tasks or event processing to ensure that the current drain is below the threshold value. Processing then continues at point L of FIG. 7A.

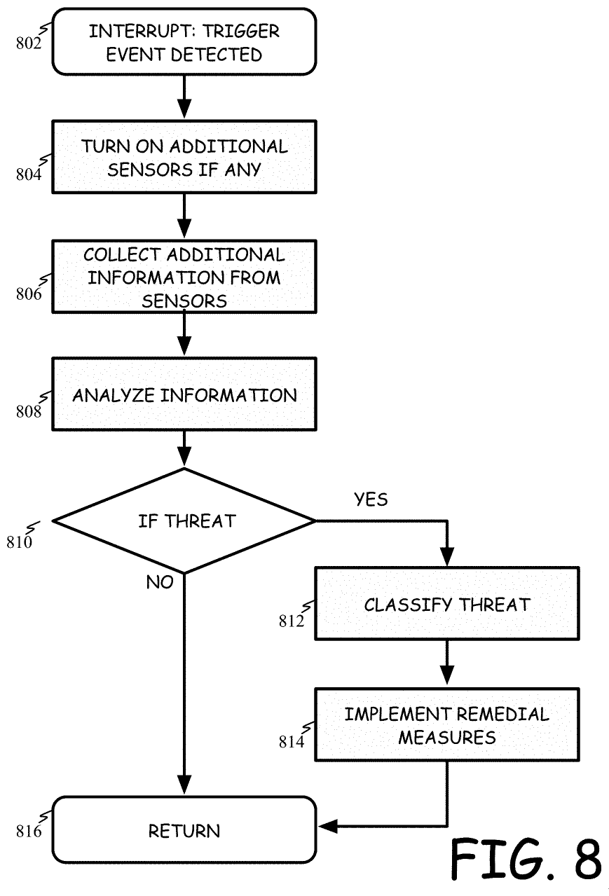

At any point in the operation of the system, the detection of a triggering event should take priority over all activity. For instance, if a sound impulse is detected, processing immediately focuses on ascertaining the identity of the sound pulse and classifying it. Thus, the sensors/detectors may operate as an “interrupt” to the system causing all processing to either vector to the threat detection process or to initiate a separate thread with highest priority to processing the triggering event. Thus, the processing of a threat detection interrupt is not illustrated in the main flow of FIGS. 7A-7K. Instead, FIG. 8 is a flowchart illustrating exemplary steps in responding to a thread detection interruption.

Looking at FIG. 8, if a triggering event is detected, processing immediately begins at step 802 regardless of what the system was processing at the time. Depending on the various embodiments, the triggering event may be a sound impulse, excessive heat, radical movement, etc. Once an event is detected, any other sensors or detectors that are off can be turned on to help assist in identifying the triggering event 804. Once the sensors collect sufficient information 806, the system can then analyze the information pertaining to the event, or multiple events, to determine if it is indicative of a threat 808.

If it is determined that the triggering event is indicative of a threat 810, the threat is classified by analyzing additional data from the sensors, as well as other information including environments, situational, current events, etc. to classify the threat 812. Finally, remedial measures are then identified and employed in response to the threat 814. As previously described, the measures may include sounding alarms, closing doors, locking doors, opening windows, calling authorities, turning on sprinklers, releasing Halon gas, shining bright lights at potential assailants, etc.

Once the threat has been responded to, the system can return to normal processing. In some embodiments a custodian or supervisor must enter a code to reset the system after a threat has been detected to ensure that the system continues to operate in a manner to identify and handle the threat. Once the threat is dealt with, processing then can return to normal 816.

Exemplary Use Cases

The above-described embodiments have generally focused on implementation of the threat detection in any general IP load. Embodiments have been described as utilizing IP speakers. It should be understood that an advantage realized by some embodiments of the present invention is that an existing, already installed system can simply be modified to incorporate the threat detection system. For instance, in the multi-room intercom/announcement system described above, simply including a software and/or firmware change to the system can add the threat detection capability to the existing system. For instance, if the system include multiple microphones, such as a microphone in the speaker or elsewhere, the software/firmware upgrade can then utilize those microphones within the threat detection system. Also, if the previously installed system does not include microphones or detectors, these elements can be added to the system along with the software/firmware addition to implement the threat detection system. Thus, it should be appreciated that any installed distributed system that includes microphones, or for which microphones can be added, may serve as an ideal platform for embodiments of the present invention.

As a non-limiting example, in various settings, such as offices, schools, malls with multiple retail stores, etc., a telephone system may server as the platform for the present invention. For instance, a VOIP telephone system with multiple IP phones, such as the CISCO desktop units (e.g. CISCO 7940, CISCO 7960, CISCO SPA 504G, Polycom SoundPoint, etc.) include a builtOin microphone utilized for hands free conversation. Such VOIP system could thus be modified to incorporate the threat detection system. As mentioned, this could be accomplished with a software/firmware upgrade or enhancement to the VOIP system or, in some embodiments a specialized box can be attached to the network on-site to implement the threat detection system.

As another non-limiting example, in our “connected world” the deployment of WIFI access points, such as the UBIQUITI WIFI access points with built-in microphones, has become widespread. Distributed systems can be deployed in a wide variety of settings, such as offices, shopping centers, schools, campuses, sporting and entertainment venues, etc. Thus, it will be appreciated that such a system can be modified to leverage the built-in microphones for various embodiments of the present invention. Similarly, this could be accomplished with a software/firmware solution to the controller or by adding a dedicated box on the network.

As another non-limiting example, security system and home/office automation systems also include various elements that include a built-in microphone. For instance, ALEXA ECHOS, RING doorbells, RING security lights/cameras, ECOBEE thermostats, GOOGLE HOME, SONOS speakers with microphones, etc., could be components of such a security/automation system. Thus, it will be appreciated that such a system can be modified to leverage the built-in microphones for various embodiments of the present invention. Similarly, this could be accomplished with a software/firmware solution to the controller or by adding a dedicated box on the network.

As another non-limiting example, in various settings, such as offices, malls with retail stores, schools, etc., in which multiple computers and/or point of sale terminals are deployed can also serve as a suitable platform for various embodiments. Typically, computers and point of sale systems include a built-in microphone. Thus, it will be appreciated that such a system can be modified to leverage the built-in microphones for various embodiments of the present invention. Similarly, this could be accomplished with a software/firmware solution to the controller or by adding a dedicated box on the network.

As another non-limiting example, in various settings, such as offices, malls, schools, entertainment venues, etc., embodiments of the threat detection system can be implemented outside of a network that is connected using PoE. For instance, mobile telephones and smart phones all include a built-in microphone. As such, within a particular environment, a controlling system can be granted access to selectively access the microphones of multiple mobile telephone and/or smart phone devices within that environment. The access could be acquired using a variety of wireless techniques including, but not limited to, WiFi, cellular data, BLUETOOTH, the service provider network, etc., as well as a combination of two or more such techniques. In such an embodiment, units can be placed into listening mode when they are not being used for other purposes. If a threat is detected, then other units in the environment can also be turned on and monitored. Thus, as an operational example, in a concert venue or a sporting event venue, patrons may be required or may volunteer to grant access to the microphone of their personal devices. This could be accomplished in a variety of manners, such as downloading an application that resides on the device, or the devices may have the capability incorporated therein by the manufacturer or service provider or, other techniques may be employed. During the event, the microphones on all or a subset of the devices can be placed into listening mode in effort to detect a threat.

Thus, it should be appreciated that the above-provided examples, as well as combinations of the above-described IP elements as well as other examples can all serve as suitable platforms for various embodiments of threat detection system. In essence, any distributed system, as well as a single point system, that include a built-in microphone or the ability to add in a microphone can server as a suitable environment that can include the software/firmware enhancement or a dedicated box to implement the threat security system.

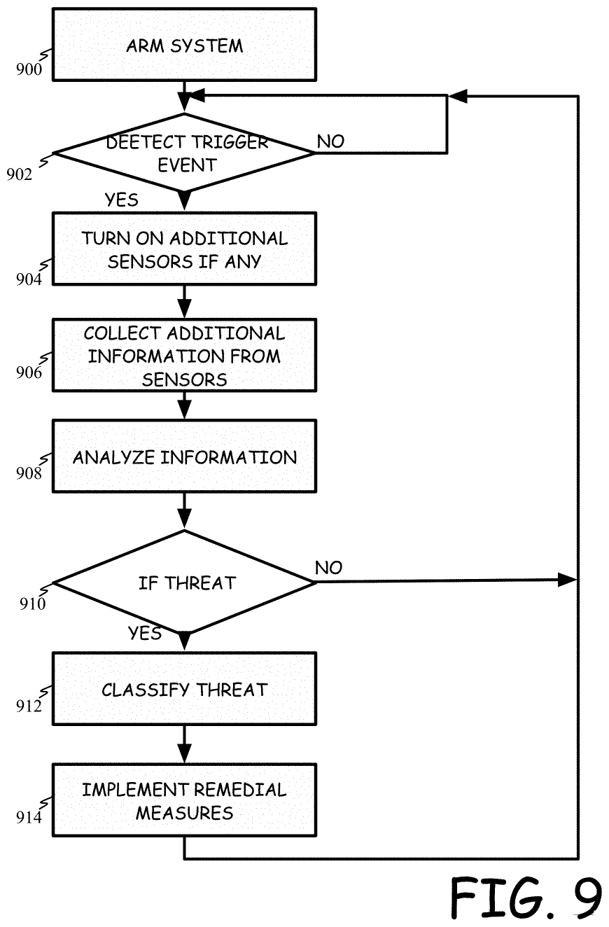

FIG. 9 is a flow diagram illustrating exemplary steps, actions or processes that can be implemented in a software/firmware enhancement to an existing system as well as by a dedicated box attached to the network of an existing system. Looking at FIG. 9, initially, the system is armed 900. This process may include identifying any microphones that are available within the system and then turning those microphones to an on or listening state. It should be appreciated that in some situations, it may be desirable to only turn on a subset of the available microphones. For instance, if there are privacy concerns, such as in a medical establishment, business, etc., a subset of the microphones that would not compromise privacy may be identified for the initial arming of the system. In addition, simply to limit processing requirements, a subset of the microphones may be strategically selected to provide a wide-spread threat detection but not sufficient to pin point the exact location. However, in some embodiments, all of the available microphones can be turned to the on or listening state. In addition, some of the microphones may have a scheduled availability or may include a privacy button to turn off the microphone or disable it for a period of time.

If a triggering event is detected 902, processing continues at step 904, otherwise, the system can wait for the detection of an event. In some embodiments, the system may enable and disable various microphones or subsets of microphones as it loops through the process of looking for an event. As previously described, based on the various embodiments, the triggering event may be a sound impulse, excessive heat, radical movement, etc. Once an event is detected, any other sensors or detectors that are off may be turned on to help assist in identifying the triggering event 904. Once the sensors collect sufficient information 906, the system can then analyze the information pertaining to the event, or multiple events, to determine if it is indicative of a threat 908.

If it is determined that the triggering event is not indicative of a threat 910, the processing may return to step 902 to listen for additional triggers. If it is determined that the triggering event is indicative of a threat 910, the threat is classified by analyzing additional data from the sensors, as well as other information including environments, situational, current events, etc. to classify the threat 912. Finally, remedial measures are then identified and employed in response to the threat 914. As previously described, the measures may include sounding alarms, closing doors, locking doors, opening windows, calling authorities, turning on sprinklers, releasing Halon gas, shining bright lights at potential assailants, etc.

Once the threat has been responded to, the system can return to step 902 to listen for additional triggers.

It should be appreciated that other events may also be employed in the various embodiments of the SCS and the illustrated events are presented as a non-limiting example.

In this application, it should be appreciated that the various components can consist of hardware, software or a combination thereof. Anything that is described as performing a function, operation or providing control may be a stand-alone unit or a specialized module consisting of any combination of hardware and/or software.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A system for extending functionality of distributed IP devices within a locale to detect and isolate threat activity, the system comprising:
a distributed system with a plurality of IP loads spaced throughout the locale, one or more of the IP loads including one or more sensors;
each of the sensors being communicatively coupled to and controlled by a sensor master that includes a controller that is operative to:
selectively turn on and off each of the sensors communicatively coupled to the sensor master;
monitor activity of the sensors when they are turned on;
detecting an activity that is indicative of a potential threat; and
identifying a category of the threat; and
initiating contingency procedures based on the category of the threat.

2. The system of claim 1, wherein the sensor master is a part of a master controller, wherein the master controller is communicatively coupled to each of the plurality of IP loads through a PoE port.

3. The system of claim 1, wherein the sensor master is part of the IP loads.

4. The system of claim 1, wherein the sensor master is software that is installed on a system operating within the distributed system.

5. The system of claim 1, wherein the sensor master is a stand-alone device connected to the same network as the distributed system.

6. The system of claim 1, wherein one or more of the sensors are microphones and the sensor master detects an activity that is indicative of a potential threat by detecting a gunshot sound.

7. The system of claim 1, wherein one or more of the sensors are optical sensors and the sensor master detects an activity that is indicative of a potential threat by detecting a muzzle flash.

8. The system of claim 1, wherein one or more of the sensors are heat sensors and the sensor master detects an activity that is indicative of a potential threat by detecting a fire.

9. The system of claim 1, wherein one or more of the sensors are microphones and the sensor master detects an activity that is indicative of a potential threat by detecting a gunshot sound and wherein the systems identifies the category of the threat as being gun fire and initiates contingency procedures by:
turning on all of the microphones in the local;
identifying the location of the gunshot sound;
locking access doors to rooms in which the gunshot sound was not detected; and
initiating a call to the police.

10. The system of claim 1, further comprising a master controller that is communicatively coupled to each of the plurality of IP loads through a PoE port and wherein each of the plurality of IP loads further comprise:
a master speaker;
a control module communicatively coupled to the master speaker;
a slave speaker system interface communicatively coupled to the control module;
a slave speaker system comprising:
an interface to the slave speaker system interface;
an analog speaker;
a sensor; and
one or more control interfaces;
wherein the control module is configured to:
register the slave speaker system with the master controller;
obtain commands received at the master speaker system intended for the slave speaker system; and
control the operation of the slave speaker control system in accordance with the received commands through the slave speaker interface; and
the slave speaker interface is configured to provide power from the single PoE port to the slave speaker system.

11. The system of claim 10, wherein one or more of the sensors are microphones and the sensor master detects an activity that is indicative of a potential threat by detecting a gunshot sound.

12. The system of claim 10, wherein one or more of the sensors are optical sensors and the sensor master detects an activity that is indicative of a potential threat by detecting a muzzle flash.

13. The system of claim 10, wherein one or more of the sensors are heat sensors and the sensor master detects an activity that is indicative of a potential threat by detecting a fire.

14. The system of claim 10, wherein one or more of the sensors are microphones and the sensor master detects an activity that is indicative of a potential threat by detecting a gunshot sound and wherein the master controller identifies the category of the threat as being gun fire and initiates contingency procedures by:
turning on all of the microphones in the local;
identifying the location of the gunshot sound;
locking access doors to rooms in which the gunshot sound was not detected; and
initiating a call to the police.

15. The system of claim 10, wherein the slave speaker system interfaces to a panic button through one of the one or more control interfaces and in response to receiving a signal indicating that the panic button has been actuated, the slave speaker system sends a signal to the control module through the slave speaker system interface indicating that the panic button has been actuated.

16. The system of claim 1, wherein the IP loads comprise an IP speaker.

17. The system of claim 1, wherein the IP loads comprise a master speaker and a control module communicatively coupled to the master speaker.

18. The system of claim 1, wherein the IP loads comprise:
a master speaker;
a control module communicatively coupled to the master speaker;
a slave IP load interface communicatively coupled to the control module;
the slave IP load system comprising:
an interface to the slave IP system interface; and
a sensor; and
wherein the control module is configured to:
register the slave IP system with the master controller;
obtain commands received at the master speaker system intended for the slave IP system; and
control the operation of the slave IP system in accordance with the received commands through the slave IP interface; and
the slave IP interface is configured to provide power from the PoE port to the slave IP system.

19. The system of claim 18, wherein one or more of the sensors are microphones and the controller of the sensor master detects an activity that is indicative of a potential threat by detecting a gunshot sound.

20. The system of claim 18, wherein one or more of the sensors are optical sensors and the controller of the sensor master detects an activity that is indicative of a potential threat by detecting a muzzle flash.

21. The system of claim 18, wherein one or more of the sensors are heat sensors and the controller of the sensor master detects an activity that is indicative of a potential threat by detecting a fire.

22. The system of claim 10, wherein the sensor master is a part of the master controller, the IP loads or distributed among both.

23. The system of claim 10, wherein the sensor master is software that is installed on a system operating within the distributed system.

24. The system of claim 10, wherein the sensor master is a stand-alone device connected to the same network as the distributed system.

25. A method for extending functionality of devices within a locale to detect and isolate threat activity, wherein one or more of the devices within the locale include a microphone, the method comprising:
a control center selectively placing one or more of the microphones into listening mode;
the control center monitoring activity of one or more of the microphones that are in listening mode;
the control center detecting an activity that is indicative of a potential threat;
the control center identifying a category of the threat; and
the control center initiating contingency procedures based on the category of the threat.
